(19) United States
(12) Patent Application Publication
(10) Pub. No.: US 2024/0049007 A1
(43) Pub. Date: Feb. 8, 2024

(54) WIRELESS COMMUNICATION METHOD, NETWORK NODE, UE AND STORAGE MEDIUM

(71) Applicant: Samsung Electronics Co., Ltd., Suwon-si (KR)

(72) Inventors: Yuanyuan ZHANG, Beijing (SG); Dan LIU, Beijing (CN); He WANG, Beijing (CN); Yankun LI, Beijing (CN); Bozhi LI, Beijing (CN); Chanho AN, Suwon-si (KR); Taekhoon KIM, Suwon-si (KR)

(21) Appl. No.: 18/450,077

(22) Filed: Aug. 15, 2023

Related U.S. Application Data
(63) Continuation of application No. PCT/KR2023/011175, filed on Jul. 31, 2023.

(30) Foreign Application Priority Data
Aug. 1, 2022 (CN) 202210916146.5
Jun. 27, 2023 (CN) 202310769059.6

(51) Int. Cl. H04W 24/02; H04W 8/24; H04B 7/0413

(52) U.S. Cl. CPC H04W 24/02; H04W 8/24; H04B 7/0413

(57) ABSTRACT

A wireless communication method, a network node, a UE and/or a storage medium are provided. A wireless communication method performed by a network node may include: receiving capability information reported by a UE regarding a carrier aggregation capability of the UE; transmitting configuration information to the UE according to the receiving capability information, wherein the configuration information includes at least one of: primary and/or secondary cell configuration of the UE; configuration to control the UE for carrier aggregation capability switching.

### RELATED APPLICATIONS

This application is a continuation application of international application No. PCT/KR2023/011175, filed on Jul. 31, 2023, which is based on and claims the benefit of Chinese Patent Application No. 202210916146.5 filed on Aug. 1, 2022; and Chinese Patent Application No. 202310769059.6 filed on Jun. 27, 2023, the disclosures of each of which are hereby entirely incorporated by reference herein.

### BACKGROUND

### Field

Certain example embodiments relate to a communication field and for example, to a wireless communication technique/system, a network node, a user equipment (UE) and/or a storage medium.

### Description of Related Art

In order to meet the increasing demand of wireless data communication services since the deployment of 4th generation (4G) communication systems, efforts have been made to develop improved 5G or pre-5G communication systems. Therefore, 5th generation (5G) or pre-5G communication systems are also called “Beyond 4G networks” or “Post-LTE systems”.

In order to achieve a higher data rate, 5G communication systems are implemented at higher frequency (millimeter, mmWave) bands, e.g., 60 GHz bands. In order to reduce propagation loss of radio waves and increase a transmission distance, technologies such as beamforming, massive multiple-input multiple-output (MIMO), full-dimensional MIMO (FD-MIMO), array antenna, analog beamforming and large-scale antenna are discussed in 5G communication systems.

In addition, in 5G communication systems, developments of system network improvement are underway based on advanced small cell, cloud radio access network (RAN), ultra-dense network, device-to-device (D2D) communication, wireless backhaul, mobile network, cooperative communication, coordinated multi-points (CoMP), reception-end interference cancellation, etc.

In 5G systems, hybrid FSK and QAM modulation (FQAM) and sliding window superposition coding (SWSC) as advanced coding modulation (ACM), and filter bank multicarrier (FBMC), non-orthogonal multiple access (NOMA) and sparse code multiple access (SCMA) as advanced access technologies have been developed.

### SUMMARY

According to the an example embodiment, there is provided a wireless communication method performed by a network node, where the wireless communication method may include: receiving capability information reported by a UE regarding a carrier aggregation capability of the UE; transmitting configuration information to the UE according to the receiving capability information, wherein the configuration information includes at least one of: primary and/or secondary cell configuration of the UE; configuration to control the UE for carrier aggregation capability switching.

The capability information may include the first information and/or the second information, wherein the first information is or comprises a signaling used to indicate the carrier aggregation capability supported by the UE and the second information is or comprises used to indicate the type of the UE carrier aggregation capability.

The first information may include at least one of:
a first signaling indicating that the UE supports intra-band New Radio (NR) carrier aggregation of non-collocated and meets the requirements of the second type of UE;
a second signaling indicating that the UE supports intra-band NR carrier aggregation of non-collocated and/or inter-band long-term evolution technology-New Radio (LTE-NR) carrier aggregation of non-collocated and meets a requirement for a third and/or fourth type of UE, wherein the third and/or fourth type of UE has a stronger multiple-input multiple-output (MIMO) capability than the second type of UE;
a third signaling indicating a maximum number of MIMO layers per cell supported by the UE for non-collocated downlink reception;
a fourth signaling indicating a maximum number of receive chains per cell supported by the UE for downlink reception;
a fifth signaling indicating a category of a downlink frequency separation between cells supported by the UE;
a sixth signaling indicating a category of an uplink frequency separation between cells supported by the UE.

The type of the carrier aggregation capability may be based on at least one of:
the UE being a second type of UE and supporting intra-band New Radio (NR)carrier aggregation of non-collocated;
the UE being a third and/or fourth type of UE and supporting intra-band NR carrier aggregation of non-collocated and/or inter-band long term evolution technology-New Radio (LTE-NR) carrier aggregation of non-collocated, wherein the third and/or fourth type of UE has a stronger multiple-input multiple-output (MIMO) capability than the second type of UE;
a maximum number of MIMO layers per cell supported by the UE for non-collocated downlink reception;
a maximum number of receive chains per cell supported by the UE for downlink reception;
a category of a downlink frequency separation between cells supported by the UE;
a category of an uplink frequency separation between cells supported by the UE.

The third and/or fourth type of UE may have a stronger multiple-input multiple-output (MIMO) capability than the second type of UE and may include at least one of:
each NR cell of the third and/or fourth type of UE supports more MIMO layers than each NR cell of the second type of UE;
each LTE cell of the third and/or fourth type of UE supports the same number of MIMO layers as each LTE cell of the second type of UE;
each LTE cell of the third and/or fourth type of UE supports more MIMO layers than each LTE cell of the second type of UE.

Each NR cell of the second type of UE may support up to two MIMO layers, each LTE cell of the second type of UE may support up to two MIMO layers, each NR cell of the third and/or fourth type of UE may support up to four MIMO layers, and each LTE cell of the third and/or fourth type of UE may support up to two or four MIMO layers.

The first signaling, the second signaling, the fifth signaling and the sixth signaling may be reported per band combination, are optional, and may be applied to a frequency range of frequency range 1 (FR1);

the third signaling may be reported per cell per band per band combination. It is a conditional reporting, and may be applied to a frequency range of FR1 and a frequency range of frequency range 2 (FR2);

the fourth signaling may be reported per cell per band per band combination. It is optional, and may be applied only to the FR1, or to both the FR1 and the FR2, in certain example embodiments.

In a case where the UE is a second type of UE and supports intra-band NR carrier aggregation of non-collocated, the first information may include at least a first signaling; and/or, in a case where the UE is a third and/or fourth type of UE and supports intra-band NR carrier aggregation of non-collocated and/or inter-band LTE-NR carrier aggregation of non-collocated, the first information may include at least a second signaling.

The requirement for the second type of UE may include a maximum receiving time difference (MRTD) requirement and/or a RF requirement for the second type of UE; the requirement for the third and/or fourth type of UE may include a MRTD requirement and/or a RF requirement for the third and/or fourth type of UE.

The transmitting of the configuration information to the UE may include: transmitting a first radio resource control (RRC) signaling to the UE for controlling the UE for carrier aggregation capability switching.

The first RRC signaling may include a first information element, the first information element may be used to indicate that the UE is to be switched between a first type of capability and another type of capability; and/or, the first RRC signaling may include a second information element, the second information element may be used to configure the primary and secondary cells to have the same number of MIMO layers.

The first information element may include a first coding bit, wherein when the first coding bit is a first value, it may indicate that the UE shall be switched from the another type of capability to the first type of capability; and when the first coding bit is a second value, it may indicate that the UE is switched from the first type of capability to the another type of capability.

The first information element may include multiple coding bits, wherein a first coding bit of the multiple coding bits may indicate that a deployment of the network node is collocated or non-collocated; and/or, a second coding bit of the multiple coding bits may indicate that an operating assumption of the network node is a synchronous assumption or an asynchronous assumption; and/or, a third coding bit of the multiple coding bits may indicate a number of MIMO layers supported by each cell of the UE.

The first RRC signaling may be transmitted to the UE in a case that a first signaling and/or a second signaling is received from the UE,
wherein the first RRC signaling may indicate that the UE is to be switched between the first type of capability and the second type of capability, in the case that the first signaling is received from the UE;
wherein, the first RRC signaling may indicate that the UE is switched between the first type of capability and a third and/or fourth type of capability, in the case that the second signaling is received from the UE;
wherein the first type of capability may be a default capability indicated for the UE;
wherein the first signaling may indicate that the UE supports intra-band New Radio (NR) carrier aggregation of non-collocated and/or meets a requirement for a second type of UE;
the second signaling may indicate that the UE supports intra-band NR carrier aggregation of non-collocated and/or inter-band long-term evolution technology-New Radio (LTE-NR) carrier aggregation of non-collocated and meets a requirement for a third and/or fourth type of UE, wherein the third and/or fourth type of UE has a stronger multiple-input multiple-output (MIMO) capability than the second type of UE.

The capability switching may include: the UE is switched from a first type of capability to a second type of capability, a third type of capability and/or a fourth type of capability; and/or, the UE is switched from the second type of capability, the third type of capability and/or the fourth type of capability to the first type of capability, wherein the first type of capability is a default capability indicated for the UE.

According to an example embodiment, there may be provided a wireless communication method performed by a user equipment (UE), where the wireless communication method may include: reporting to a network node capability information regarding a carrier aggregation capability of the UE; receiving configuration information transmitted by the network node, wherein the configuration information includes at least one of: primary and/or secondary cell configuration of the UE; configuration to control the UE for carrier aggregation capability switching.

The capability information may include first information and/or second information, wherein the first information may be a signaling for indicating the carrier aggregation capability supported by the UE and the second information may be used to indicate a type of the carrier aggregation capability of the UE.

The first information may include at least one of:
a first signaling indicating that the UE supports intra-band New Radio (NR)carrier aggregation of non-collocated and meets a requirement for a second type of UE;
a second signaling indicating that the UE supports intra-band NR carrier aggregation of non-collocated and/or inter-band long-term evolution technology-New Radio (LTE-NR) carrier aggregation of non-collocated and meets a requirement for a third and/or fourth type of UE, wherein the third and/or fourth type of UE has a stronger multiple-input multiple-output (MIMO) capability than the second type of UE;
a third signaling indicating a maximum number of MIMO layers per cell supported by the UE for non-collocated downlink reception;
a fourth signaling indicating a maximum number of receive chains per cell supported by the UE for downlink reception;
a fifth signaling indicating a category of a downlink frequency separation between cells supported by the UE;
a sixth signaling indicating a category of an uplink frequency separation between cells supported by the UE.

The type of the carrier aggregation capability may be based on at least one of:
the UE being a second type of UE and supporting intra-band New Radio (NR) carrier aggregation of non-collocated;
the UE being a third and/or fourth type of UE and supporting intra-band NR carrier aggregation of non-collocated and/or inter-band long term evolution technology-New Radio (LTE-NR) carrier aggregation of non-collocated, wherein the third and/or fourth type of UE has a stronger multiple-input multiple-output (MIMO) capability than the second type of UE;
a maximum number of MIMO layers per cell supported by the UE for non-collocated downlink reception;
a maximum number of receive chains per cell supported by the UE for downlink reception;
a category of a downlink frequency separation between cells supported by the UE;
a category of an uplink frequency separation between cells supported by the UE.

The third and/or fourth type of UE may have a stronger multiple-input multiple-output (MIMO) capability than the second type of UE and may include at least one of:
each NR cell of the third and/or fourth type of UE supports more MIMO layers than each NR cell of the second type of UE;
each LTE cell of the third and/or fourth type of UE supports the same number of MIMO layers as each LTE cell of the second type of UE;
each LTE cell of the third and/or fourth type of UE supports more MIMO layers than each LTE cell of the second type of UE.

Each NR cell of the second type of UE may support up to two MIMO layers, each LTE cell of the second type of UE may support up to two MIMO layers, each NR cell of the third and/or fourth type of UE may support up to four MIMO layers, and each LTE cell of the third and/or fourth type of UE may support up to two or four MIMO layers.

The first signaling, the second signaling, the fifth signaling and the sixth signaling may be reported per band combination, are not mandatory, and may be applied to a frequency range of FR1; the third signaling may be reported per cell per band per band combination, conditional mandatory reporting, and may be applied to a frequency range of FR1 and a frequency range of FR2; the fourth signaling may be reported per cell per band per band combination, is not mandatory, and may be applied only to the FR1, or to both the FR1 and the FR2.

In a case where the UE is a second type of UE and supports intra-band NR carrier aggregation of non-collocated, the first information may include at least a first signaling; and/or, in a case where the UE is a third and/or fourth type of UE and supports intra-band NR carrier aggregation of non-collocated and/or inter-band LTE-NR carrier aggregation of non-collocated, the first information may include at least a second signaling.

The second type of UE may include a maximum receiving time difference (MRTD) requirement and/or a RF requirement for the second type of UE; the third and/or fourth type of UE may include a MRTD requirement and/or a RF requirement for the third and/or fourth type of UE.

The receiving of the configuration information transmitted by the network node may include: receiving a first radio resource control (RRC) signaling for controlling the UE for carrier aggregation capability switching.

The first RRC signaling may include a first information element, the first information element may be used to indicate the UE is switched between a first type of capability and another type of capability; and/or, the first RRC signaling includes a second information element, the second information element may be used to configure the primary and secondary cells to have the same number of MIMO layers.

The first information element may include a first coding bit, wherein when the first coding bit is a first value, it may indicate the UE is switched from the another type of capability to the first type of capability; and when the first coding bit is a second value, it may indicate that the UE is switched from the first type of capability to the another type of capability.

The first information element may include multiple coding bits, wherein a first coding bit of the multiple coding bits may indicate that a deployment of the network node is collocated and/or non-collocated; and/or, a second coding bit of the multiple coding bits may indicate that an operating assumption of the network node is a synchronous assumption and/or an asynchronous assumption; and/or, a third coding bit of the multiple coding bits may indicate a number of MIMO layers supported by each cell of the UE.

The first RRC signaling may be received from the network node in a case where the UE reports a first signaling and/or a second signaling to the network node,
wherein the first RRC signaling may indicate that the UE is switched between the first type of capability and the second type of capability, in a case where the UE reports the first signaling to the network node;
wherein, the first RRC signaling may indicate that the UE is switched between the first type of capability and a third and/or fourth type of capability, in a case where the UE reports the second signaling to the network node;
wherein the first type of capability may be a default capability indicated for the UE;
wherein the first signaling may indicate that the UE supports intra-band New Radio (NR) carrier aggregation of non-collocated and meets a requirement for a second type of UE;
the second signaling may indicate that the UE supports intra-band NR carrier aggregation of non-collocated and/or inter-band long-term evolution technology-New Radio (LTE-NR) carrier aggregation of non-collocated and meets a requirement for a third and/or fourth type of UE, wherein the third and/or fourth type of UE has a stronger multiple-input multiple-output (MIMO) capability than the second type of UE.

The wireless communication method may include: performing capability switching of the UE according to the first RRC signaling; performing a behavior corresponding to a switched type of capability according to the type of capability, wherein the behavior may include a first behavior and/or a second behavior, the first behavior may include a behavior of the UE under collocated carrier aggregation and the second behavior may include a behavior of the UE under non-collocated carrier aggregation.

The wireless communication method may include: reporting a first RRC signaling configuration completion indication to the network node after performing the capability switching, wherein a time for reporting the first RRC signaling configuration completion indication may be related to an RRC configuration delay caused by the capability switching.

A value of the RRC configuration delay may be determined based on a first interruption time, wherein the first interruption time may be determined based on a first preparation time associated with the capability switching and/or a type of the capability switching; and/or wherein an applicable condition of the RRC configuration delay may be determined based on the capability information reported by the UE and/or the first RRC signaling. “Based on” as used herein covers based at least on.

The wireless communication method may include: performing secondary cell activation when a secondary cell activation command is received from the network node, wherein a time of the secondary cell activation may be related to an activation delay caused by the capability switching.

A value of the activation delay may be determined based on a first activation time, wherein the first activation time may be determined based on an adjustment time associated with the capability switching and/or a type of the capability switching; and/or wherein an applicable condition of the activation delay may be determined based on the capability information reported by the UE and/or the first RRC signaling.

The type of the capability switching may include: the UE is switched from a first type of capability to a second type of capability, a third type of capability and/or a fourth type of capability; and/or, the UE is switched from the second type of capability, the third type of capability and/or the fourth type of capability to the first type of capability, wherein the first type of capability may be a default capability indicated for the UE.

According to an example embodiment, there may be provided a network node, where the network node may include: a transceiver; at least one processor coupled, directly or indirectly, to the transceiver and configured to perform at least one of the above wireless communication method(s) performed by the network node.

According to an example embodiment, there may be provided a user equipment, where the user equipment may include: a transceiver; at least one processor coupled, directly or indirectly, to the transceiver and configured to perform at least one of the above wireless communication method(s) performed by the user equipment.

According to an example embodiment, there may be provided a computer readable storage medium storing instructions that, when run by at least one processor, cause the at least one processor to perform at least one of the above wireless communication method(s).

The technical solutions bring one or more of the following beneficial effects: according to the above wireless communication methods, a UE may report capability information to a network node regarding a carrier aggregation capability of the UE, and the network node may transmit configuration information to the UE based on the received capability information, and the configuration information includes at least one of: primary and/or secondary cell configuration of the UE; configuration to control the UE for carrier aggregation capability switching. On top of such design, a more rational carrier aggregation deployment and/or dynamic capability switching of the UE is enabled.

It should be understood that the above general descriptions and the following detailed descriptions are only illustrative and explanatory, and do not limit the present disclosure.

### BRIEF DESCRIPTION OF THE DRAWINGS

The accompanying drawings herein are incorporated into the specification and form a part of the specification, showing exemplary embodiments in accordance with the present disclosure and used together with the specification to explain the principles of the present disclosure, and do not constitute an improper limitation of the present disclosure.

FIG. 1 illustrates an example wireless network according to various example embodiments;

FIG. 2a and FIG. 2b illustrate an example wireless transmission path and an example wireless reception path according to an example embodiment;

FIG. 3a illustrates an example UE 116 according to an example embodiment;

FIG. 3b illustrates an example gNB 102 according to an example embodiment;

FIG. 4 illustrates a schematic diagram of an example need for carrier aggregation deployment;

FIG. 5 is a schematic diagram of an example collocated carrier aggregation and non-collocated carrier aggregation;

FIG. 6 is a schematic diagram of an example UE being switched between different capabilities under collocated carrier aggregation and non-collocated carrier aggregation scenarios;

FIG. 7 is a flowchart of a wireless communication method performed by a user equipment (UE) according to an exemplary embodiment;

FIG. 8 is a schematic diagram of a user equipment performing capability switching according to an exemplary embodiment;

FIG. 9 illustrates an example overall signal flow diagram for communication between the network node and the UE;

FIG. 10 is a schematic diagram of when the UE reports the first radio resource control (RRC) signaling configuration completion indication (RRC configuration delay) after the introduction of the first RRC signaling according to an exemplary embodiment;

FIG. 11 is a schematic diagram of secondary cell (SCell) activation after considering a capacity switching behavior according to an exemplary embodiment;

FIG. 12 is a schematic diagram of automatic gain control (AGC) adjustment after considering a capability switching behavior according to an exemplary embodiment;

FIG. 13 is a flowchart illustrating a wireless communication method performed by a network node according to an exemplary embodiment;

FIG. 14 illustrates a block diagram of a user equipment according to an exemplary embodiment;

FIG. 15 illustrates a block diagram of a network node according to an exemplary embodiment.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein may be made without departing from the scope and spirit of the present disclosure. In addition, descriptions of well-known functions and constructions may be omitted for clarity and conciseness.

The terms and words used in the following description and claims are not limited to the bibliographical meanings, but, are merely used to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include” or “may include” refers to the existence of a corresponding disclosed function, operation or component which may be used in various embodiments of the present disclosure and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the present disclosure includes any or all of combinations of listed words. For example, the expression “A or B” may include A, may include B, or may include both A and B.

Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the meanings equal to the contextual meanings in the relevant field of art, and are not to be interpreted to have conceptually or excessively formal meanings unless clearly defined in the present disclosure.

The exemplary embodiments of the present disclosure are further described below in conjunction with the accompanying drawings. The text and drawings are provided as examples only to help readers understand the present disclosure. They are not intended and should not be interpreted as limiting the scope of the present disclosure in any way. Although certain embodiments and examples have been provided, based on the content disclosed herein, it is clear to those skilled in the art that modifications to the illustrated embodiments and examples may be made without departing from the scope.

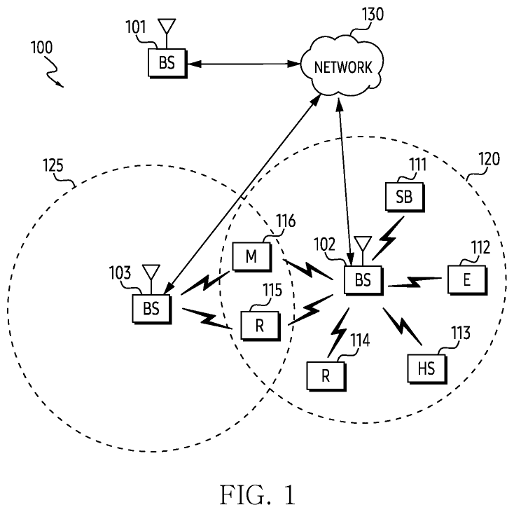

FIG. 1 illustrates an example wireless network 100 according to various example embodiments. The embodiment of the wireless network 100 shown in FIG. 1 is for illustration only. Other embodiments of the wireless network 100 may be used without departing from the scope of the present disclosure.

The wireless network 100 includes a gNodeB (gNB) 101, a gNB 102, and a gNB 103. gNB 101 communicates with gNB 102 and gNB 103. gNB 101 also communicates with at least one Internet Protocol (IP) network 130, such as the Internet, a private IP network, or other data networks.

Depending on a type of the network, other well-known terms such as “base station” or “access point” may be used instead of “gNodeB” or “gNB”. For convenience, the terms “gNodeB” and “gNB” are used in this patent document to refer to network infrastructure components that provide wireless access for remote terminals. And, depending on the type of the network, other well-known terms such as “mobile station”, “user station”, “remote terminal”, “wireless terminal” or “user apparatus” may be used instead of “user equipment” or “UE”. For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

gNB 102 provides wireless broadband access to the network 130 for a first plurality of User Equipments (UEs) within a coverage area 120 of gNB 102. The first plurality of UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. gNB 103 provides wireless broadband access to network 130 for a second plurality of UEs within a coverage area 125 of gNB 103. The second plurality of UEs include a UE 115 and a UE 116. In some embodiments, one or more of gNBs 101-103 can communicate with each other and with UEs 111-116 using 5G, Long Term Evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a 2D antenna array as described in example embodiments. In some embodiments, one or more of gNB 101, gNB 102, and gNB 103 support codebook designs and structures for systems with 2D antenna arrays.

Although FIG. 1 illustrates an example of the wireless network 100, various changes may be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

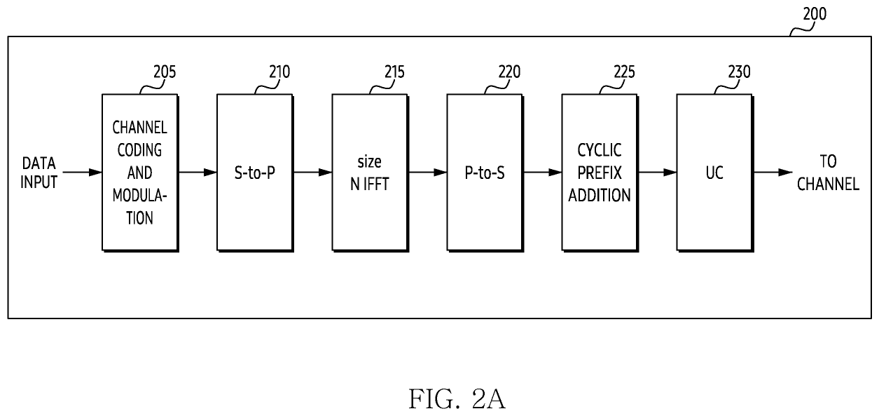

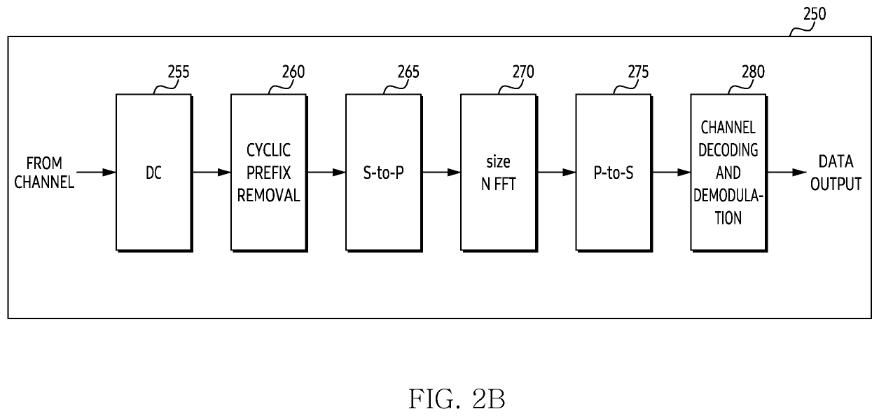

FIGS. 2a and 2b illustrate example wireless transmission and reception paths according to an example embodiment. In the following description, the transmission path 200 may be described as being implemented in a gNB, such as gNB 102, and the reception path 250 may be described as being implemented in a UE, such as UE 116. However, it should be understood that the reception path 250 may be implemented in a gNB and the transmission path 200 may be implemented in a UE. In some embodiments, the reception path 250 is configured to support codebook designs and structures for systems with 2D antenna arrays as described in example embodiments.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time domain output signal. The Parallel-to-Serial block 220 converts (such as multiplexes) parallel time domain output symbols from the Size N IFFT block 215 to generate a serial time domain signal. The cyclic prefix addition block 225 inserts a cyclic prefix into the time domain signal. The up-converter 230 modulates (such as up-converts) the output of the cyclic prefix addition block 225 to an RF frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time domain baseband signal. The Serial-to-Parallel block 265 converts the time domain baseband signal into a parallel time domain signal. The Size N FFT block 270 performs an FFT algorithm to generate N parallel frequency domain signals. The Parallel-to-Serial block 275 converts the parallel frequency domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2a and 2b may be implemented using only hardware, or using a combination of hardware and software/firmware. As a specific example, at least some of the components in FIGS. 2a and 2b may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the present disclosure. Other types of transforms may be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2a and 2b illustrate examples of wireless transmission and reception paths, various changes may be made to FIGS. 2a and 2b. For example, various components in FIGS. 2a and 2b may be combined, further subdivided or omitted, and additional components may be added according to specific requirements. Furthermore, FIGS. 2a and 2b are intended to illustrate examples of types of transmission and reception paths that may be used in a wireless network. Any other suitable architecture may be used to support wireless communication in a wireless network.

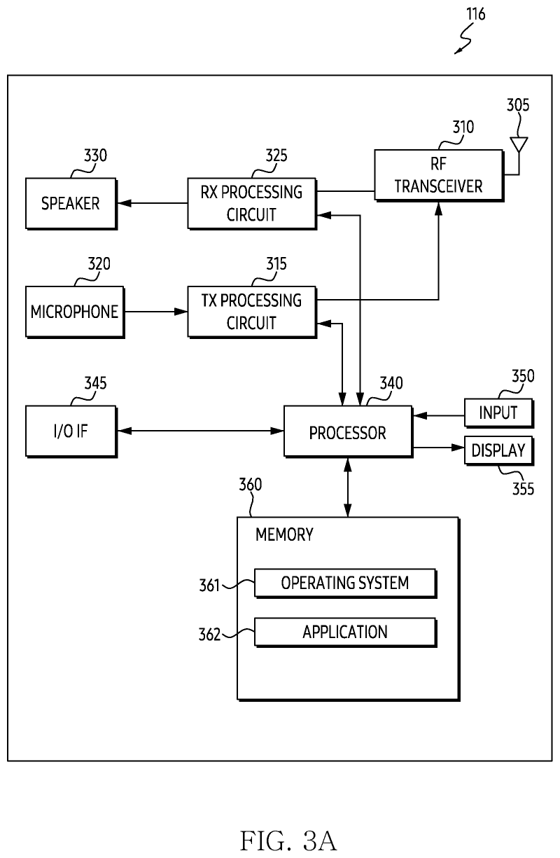

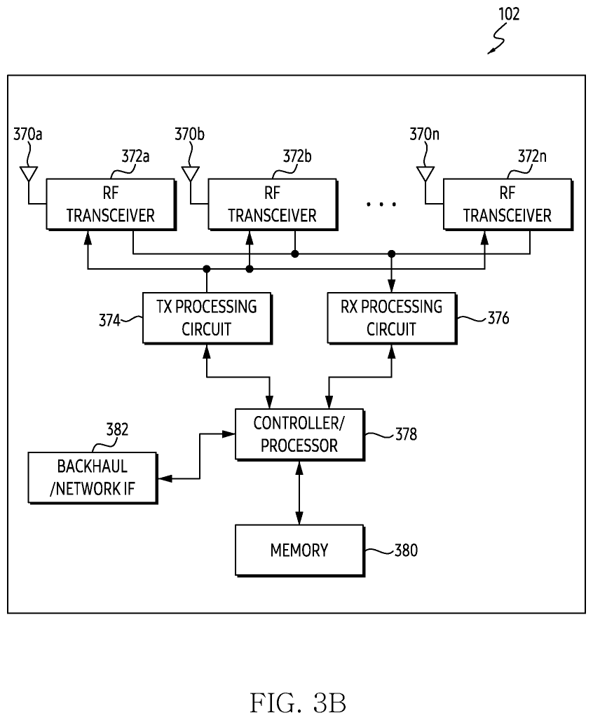

FIG. 3a illustrates an example UE 116 according to an example embodiment. The embodiment of UE 116 shown in FIG. 3a is for illustration only, and UEs 111-115 of FIG. 1 can have the same or similar configuration. However, a UE has various configurations, and FIG. 3a does not limit the scope of the present disclosure to any specific implementation of the UE.

UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in example embodiments. The processor/controller 340 can move data into or out of the memory 360 as required by an execution process. In some embodiments, the processor/controller 340 is configured to execute the application 362 based on the OS 361 or in response to signals received from the gNB or the operator. The processor/controller 340 is also coupled, directly or indirectly, to an I/O interface 345, where the I/O interface 345 provides UE 116 with the ability to connect to other devices such as laptop computers and handheld computers. I/O interface 345 is a communication path between these accessories and the processor/controller 340.

The processor/controller 340 is also coupled, directly or indirectly, to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3a illustrates an example of UE 116, various changes may be made to FIG. 3a. For example, various components in FIG. 3a may be combined, further subdivided or omitted, and additional components may be added according to specific requirements. As a specific example, the processor/controller 340 may be divided into a plurality of processors, such as one or more central processing units (CPUs) and one or more graphics processing units (GPUs). Furthermore, although FIG. 3a illustrates that the UE 116 is configured as a mobile phone or a smart phone, UEs may be configured to operate as other types of mobile or fixed devices.

FIG. 3b illustrates an example gNB 102 according to an example embodiment. The embodiment of gNB 102 shown in FIG. 3b is for illustration only, and other gNBs of FIG. 1 can have the same or similar configuration. However, a gNB has various configurations, and FIG. 3b does not limit the scope of the present disclosure to any specific implementation of a gNB. It should be noted that gNB 101 and gNB 103 can include the same or similar structures as gNB 102.

As shown in FIG. 3b, gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and up-convert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-layer wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in example embodiments. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3b illustrates an example of gNB 102, various changes may be made to FIG. 3b. For example, gNB 102 can include any number of each component shown in FIG. 3a. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

Wireless communication is one of the most successful innovations in modern history. Recently, the number of subscribers to wireless communication services exceeded 5 billion and continues to grow rapidly. Due to the growing popularity of smartphones and other mobile data devices (e.g., tablets, laptops, netbooks, e-book readers, and machine-type devices) among consumers and enterprises, the demand for wireless data services is growing rapidly, thus it is even more important to make a network node to better understand a carrier aggregation capability of a UE, and better understanding of the carrier aggregation capability of the UE facilitates better carrier aggregation deployment by the network node.

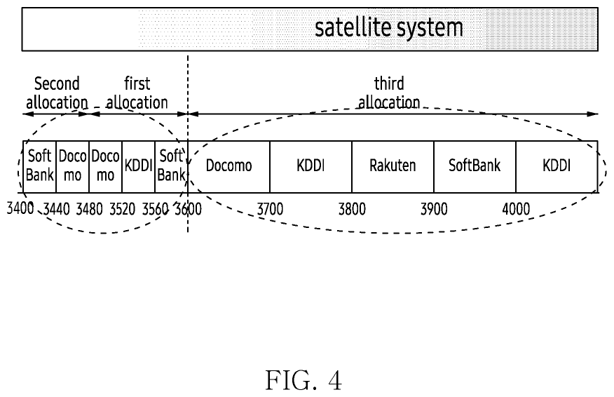

For example, a same band will be allocated to an operator at different times, as shown in FIG. 4, a band of C-band (3400-4200 MHz) of an operator KDDI has three sub-carrier blocks, 3520-3560 MHz is allocated to the KDDI first (first time period allocation), so early base stations may only support 3520-3560 MHz, while 3700-3800 MHz and 4000-4100 MHz are allocated to the KDDI later (second time period allocation), and some of later base stations only support 3700-3800 MHz and 4000-4100 MHz. However, between the sub-carrier blocks in the first and second time period allocation, the operator has a need for carrier aggregation deployment. Carrier aggregation may be performed between Long Term Evolution (LTE) and New Radio (NR), or between NRs. EUTRA-NR Dual Connectivity (E-UTRAN NR Dual Connectivity, ENDC) is carrier aggregation between LTE and NR, and NR Carrier Aggregation (NRCA) is carrier aggregation between NRs.

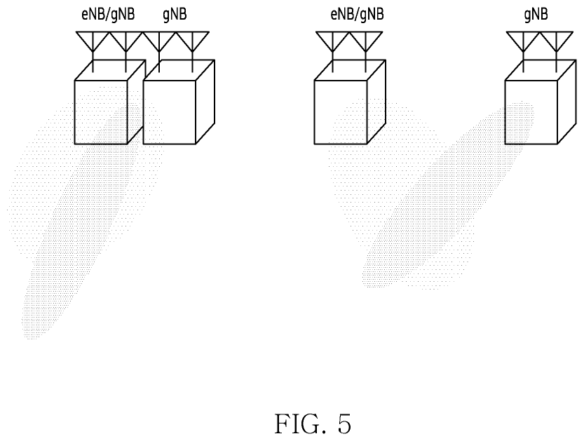

FIG. 5 shows a schematic diagram of collocated carrier aggregation and non-collocated carrier aggregation.

An inter-band ENDC_42_n77 and an intra-band n77 (2A) are used as examples for explanation.

A difference between the collocated CA and the non-collocated CA is shown in FIG. 5. For the inter-band ENDC 42_n77 (42 and n77 belong to bands with overlapping frequencies), the collocated CA may be simply understood as a base station transmitting both 4G and 5G signals, or a 4G base station (eNB) and a 5G base station (gNB) being so close to each other that they can transmit 42 and n77 simultaneously, so the time for the signals from the base stations to reach a UE is almost the same (for example, a maximum receiving time difference (MRTD) is less than 3 μs, the MRTD less than 3 us may be simply understood as signal synchronization and without need of any time difference, the MRTD is a maximum receiving time difference that the UE can handle, that is, the maximum time difference between cells of b42 and n77 that the UE can handle). In addition, The collocated CA also requires that power imbalance between 42 and n77 is also small (less than 6 dB), otherwise the UE cannot handle it, because the collocated CA requires an Rx Chain to handle both b42 and n77, e.g., there is a need to share local oscillation (Lo), automatic gain control (AGC) between 42 and n77, so the power imbalance cannot be too large.

For the non-collocated, it may be simply understood that 4G and 5G are separate base stations and separated by a certain distance, the 4G base station transmits b42, the 5G base station transmits n77, in order to support the non-collocated CA, the power imbalance between cells (42 and n77) received by the UE is allowed to be no more than 25 dB, the MRTD is less than 33 μs. An intra-band CA_77 (2A) follows the same principle, for example, for the non-collocated CA, one base station can transmit cc 1 at 3520-3560 MHz and another base station can transmit cc 2 at 4000-4100 MHz.

For MIMO, as a UE capability, it has been indicated for a first type of UE (a Type1 UE) and a second type of UE (a Type2 UE). The Type1 UE supports collocated carrier aggregation and for the Type1 UE, both ENDC and NRCA are indicated. The Type2 UE supports non-collocated carrier aggregation. For the Type2 UE, only the inter-band ENDC is indicated. However, with respect to the Type2 UE, it is not indicated for an intra-band NRCA. Therefore, the present disclosure proposes to add definition of the intra-band NRCA for the Type2 UE.

In addition, previously, due to limitation of a RF architecture of the UE, the Type2 UE can only support up to two MIMO layers (2 layers)/up to two received links (2RX chains) per cell, e.g., support up to 2 layers/2RX chains per cc, and the receiving throughput of the UE is not high. The Type1 (collocated) UE can support up to 4 layer per cc, but the total number of Rx Chains is four. In order to enhance downlink throughput, for the non-collocated CA, it is desired that the UE has a stronger MIMO capability, e.g., support 4 layer per cc (the LTE cell can support 2 layer if the RF architecture is challenging, but the NR cell still supports 4 layer). However, there is no definition of a UE with a stronger MIMO capability. Therefore, the present disclosure proposes to define a UE with a stronger MIMO capability, and in the following, the UE with a stronger MIMO capability is referred to as a third type of UE (a Type3 UE) or a fourth type of UE (a Type4 UE). The Type3 UE or the Type4 UE supports non-collocated CA and has a stronger MIMO capability. The present disclosure proposes that for the Type3 UE or the Type4 UE, non-collocated NR intra-band carrier aggregation (in the following, referred to as “Intra-band NRCA”) and non-collocated long term evolution technology-New Radio (LTE-NRE) inter-band carrier aggregation (e.g., non-collocated Inter-band ENDC) are indicated, respectively.

Regarding the Type2 UE, the Intra-band NRCA is not currently indicated for the Type2 UE. To address this issue, the present disclosure proposes to define the Intra-band NRCA for the Type2 UE.

In addition, there are no definitions for the Type3 UE and the Type4 UE. To address this issue, the present disclosure proposes to define the Type3 UE and the Type4 UE, including definition of the non-collocated inter-band ENDC and the Intra-band NRCA.

According to the example embodiments, a UE capability and a relationship between the UE capability and a BS deployment may for example be shown in Table 1 below:

TABLE 1
A UE capability and a relationship between the UE capability and a BS deployment

| | Type1 capability | | | |
|---|---|---|---|---|
| | (default | | | |
| | implementation, | Type2 capability | Type3 capability | Type4 capability |
| | for collocated | (for non-collocated | (for non-collocated | (for non-collocated |
| | deployment) | deployment) | deployment) | deployment) |
| Power | e.g., 6 dB/3 μs | e.g., 25 dB/33 μs | e.g., between 6 and | e.g., 25 dB/33 μs |
| imbalance/MRTD | | | 33 dB/between 3 | |
| between 2CC | | | and 33 μs | |
| Maximum Rx | e.g., maximum 4 | e.g., maximum 2 | e.g., maximum 4 | e.g., maximum 4 |
| chains/MIMO | layers/Rx per CC | layers/Rx per CC | layers/Rx per CC | layers/Rx per CC |
| layers | | | | |
| Rx Chain between | Shared | Separated | Partially shared | Separated |
| 2CCs | | | | |

In addition, the carrier aggregation capability of the UE is affected by the RF architecture, and since the possible RF architectures are multiple and involve multiple parameters, different UEs may have different carrier aggregation capabilities and support different configuration, but the network side does not know these capability information of the UE. To address this issue, if the UE can report these capability information, it will enable the network to fully understand the carrier aggregation capability of the UE and make a rational carrier aggregation deployment for the carrier aggregation capability of the UE.

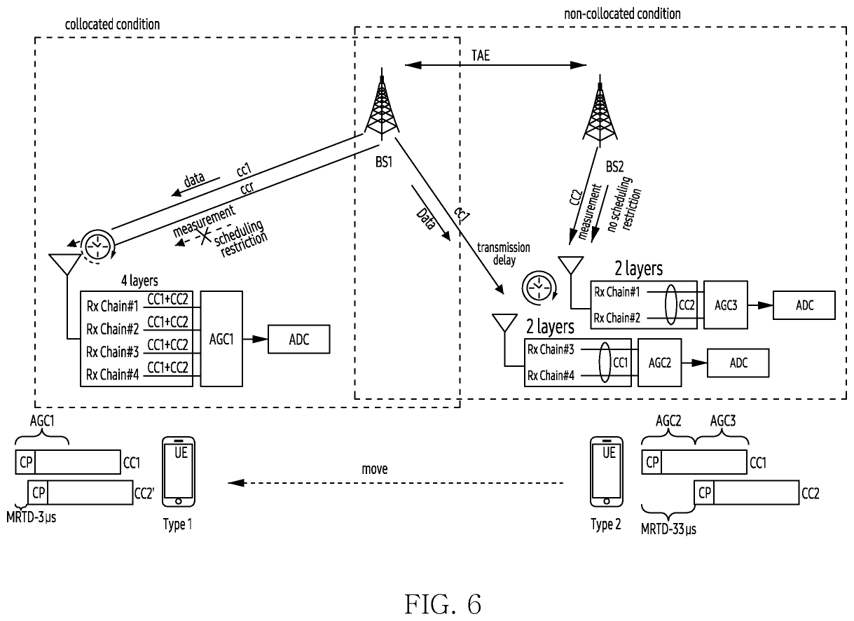

FIG. 6 shows a diagram of a UE being switched between different capabilities under collocated carrier aggregation and non-collocated carrier aggregation scenarios.

The following takes capabilities of the Type2 UE and the Type1 UE as an example to explain.

The UE supports a Type2 capability when the BS is in a non-collocated carrier aggregation deployment. In this case, the RF architecture of the Type2 UE is followed, that is, it can only support up to 2 layers/2 RX chains per cc (UE has four Rx chains in total). Each Rx chain is connected, directly or indirectly, to a separate automatic gain control (AGC) and analog-to-digital converter (ADC) unit, and the MRTD between the two CCs is 33 μs. When the BS is in a collocated carrier aggregation deployment, the UE shall fall back to support the Type1 capability. The RF architecture of the Type1 UE is followed, e.g., it can support up to 4 layers/4 RX chains per cc (the UE has 4 Rx chains in total), so two CCs share an AGC and ADC unit on each Chain, and the MRTD between the two CCs is 3 μs<CP.

However, although according to the consensus, e.g., for a UE supporting a TypeY capability, where the TypeY may be the Type2 or the Type3 and the Type1 is the default implementation, the TypeY capability reported by the UE is constant and the TypeY capability does not satisfy the backward compatibility feature, if the UE indicates to support the TypeY capability, it only meets a TypeY requirement and the UE only performs a behavior corresponding to the TypeY. In other words, when the BS deployment scenario (between the non-collocated and collocated deployments) changes, the UE supporting the TypeY cannot switch between the TypeY capability and the Type1 (default), cannot fall back to the Type1 UE, and cannot work as the Type1 UE. This has the following serious effects: greatly reduced data transmission rate, halved system throughput performance, greatly reduced data decoding accuracy, inability of the UE to receive data from the same BS performing measurement, and inefficient resource utilization.

To address this problem, the present disclosure also proposes that network controls dynamic capability switching of a UE, the network configures a first RRC signaling such that the UE can perform different capability switching when a deployment scenario (between a non-collocated deployment and a collocated deployment) changes.

At the same time, according to the existing signaling flow between the network and the UE, the network configuration of the first RRC signaling occurs during the RRC reconfiguration phase, and since the scenario considered for the type capability switching is a carrier aggregation deployment scenario, when the Type1 and TypeY capabilities are switched, the configuration of the secondary cell (SCell) (the configuration of the secondary cell may be added or released) may be affected. This introduces new impact parameters that may lead to a new RRC configuration delay. However, there is no discussion on the new impact of different capability switching on the behavior of the UE in an aspect of the RRC reconfiguration. At the same time, the introduction of the type capability switching would bring a new impact on SCell activation and introduce new impact parameters, which in turn may lead to a new SCell activation delay of the UE. However, there is no discussion about the new impact of different capability switching on the behavior of the UE in an aspect of the SCell activation.

Therefore, the present disclosure also proposes a new behavior of the UE when the UE is configured to allow switching between different types of capabilities. The new behavior of the UE includes: how the UE to switch between different types of capabilities; the new impact on the behavior of the UE (the new RRC reconfiguration delay) caused by the capability switching action, in the aspect of the RRC reconfiguration; and the new impact on the behavior of the UE (the new SCell activation delay) caused by the capability switching action, in the aspect of the SCell activation.

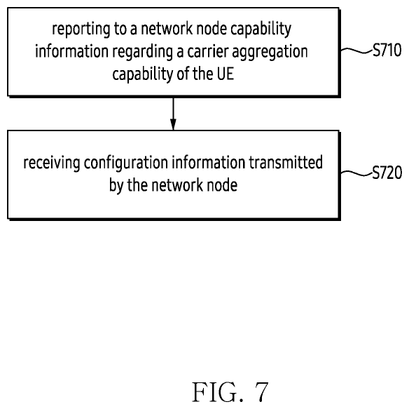

FIG. 7 is a flowchart of a wireless communication method performed by a user equipment (UE) according to an exemplary embodiment of the present disclosure.

Referring to FIG. 7, at step S710, capacity information reported by the UE regarding a carrier aggregation capability of the UE is sent by the UE and received by the node. According to an embodiment, the capability information may include first information and/or second information.

For example, the first information may be a signaling for indicating the carrier aggregation capability supported by the UE.

As an example, the first information may include at least one of:
a first signaling indicating that the UE supports intra-band New Radio (NR)carrier aggregation of non-collocated and meets a requirement for a second type of UE;
a second signaling indicating that the UE supports intra-band NR carrier aggregation of non-collocated or inter-band long-term evolution technology-New Radio (LTE-NR) carrier aggregation of non-collocated and meets a requirement for a third or fourth type of UE, wherein the third or fourth type of UE has a stronger multiple-input multiple-output (MIMO) capability than the second type of UE;
a third signaling indicating a maximum number of MIMO layers per cell supported by the UE for non-collocated downlink reception;
a fourth signaling indicating a maximum number of receive chains per cell supported by the UE for downlink reception;
a fifth signaling indicating a category of a downlink frequency separation between cells supported by the UE;
a sixth signaling indicating a category of an uplink frequency separation between cells supported by the UE.

According to an embodiment, in a case where the UE is a second type of UE and supports intra-band NR carrier aggregation of non-collocated, the first information may include at least a first signaling. That is, in the case where the UE is a Type 2 UE and supports non-collocated Intra-band NRCA, the UE reports at least the first signaling. Furthermore, optionally, in this case, at least one of the third signaling to the sixth signaling may also be reported, or may be not reported.

According to an embodiment, in a case where the UE is a third or fourth type of UE and supports intra-band NR carrier aggregation of non-collocated or inter-band LTE-NR carrier aggregation of non-collocated, the first information may include at least a second signaling. That is, in the case where the UE is a Type 3 UE or a Type 4 UE and supports non-collocated Intra-band NRCA or non-collocated Inter-band ENDC, the UE reports at least the second signaling. Furthermore, optionally, in this case, at least one of the third signaling to the sixth signaling may also be reported, or may be not reported.

According to an embodiment, in a case where the first information includes at least the first signaling or the second signaling, the capability information reported by the UE may be used by the network node to perform deployment for non-collocated carrier aggregation of the UE.

According to an embodiment, the fourth signaling to the sixth signaling may be a general information element (IE), both for non-collocated Intra-band NRCA of the Type 2 UE and for non-collocated Intra-band NRCA and non-collocated Inter-band ENDC of the Type 3 UE or the Type 4 UE, and also for collocated carrier aggregation of the Type1 UE. The fourth signaling, fifth signaling and sixth signaling are not required to be reported together, they are independent of each other and are also independent with the first signaling, the second signaling and the third signaling, they may be reported together with the first signaling, second signaling and third signaling, or not.

In the following, the first signaling to the sixth signaling are described separately.

Regarding the First Signaling:

As mentioned above, for the Type2 UE (non-collocated), the inter-band ENDC has been indicated as shown in the signaling inter-bandMRDC-WithOverlapDL-Bands-r16, thus, optionally, the present disclosure may refer to the design of inter-bandMRDC-WithOverlapDL-Bands-r16 to design the signaling for the intra-band NRCA of the Type2 UE, e.g., the first signaling.

The first signaling may indicate that the UE supports the non-collocated intra-band NRCA and meets the requirement for the Type2 UE. As an example, the requirement for the Type2 UE may include a maximum receiving time difference (MRTD) requirement and/or a RF requirement for the Type2 UE. The RF requirement may include, for example, a requirement for the maximum number of Rx chains supported per cell; an intra-band blocking requirement (power imbalance, receiving reference sensitivity relaxation); a requirement for the maximum number of MIMO layers supported per cell; a requirement for a frequency separation, etc.

It should be noted that the first signaling may be designed in a variety of ways, as long as it indicates that the UE supports the non-collocated intra-band NRCA and meets the requirement for the second type of UE. Reporting this signaling indicates that the UE is the Type 2 UE and that the UE supports time-division duplex (TDD) or frequency-division duplex (FDD) intra-band CA and meets the MRTD requirement (MRTD<X μs) as indicated in 38.133 and RF requirements of the Type 2; if the UE does not report this signaling, it indicates that the UE is the Type1 UE, the intra-band CA of TDD or FDD supported by the UE needs to satisfy the MRTD<3 μs as indicated in 38.133 and RF requirements for the Type1 UE.

This signaling is reported per band combination, is not mandatory (optional), and is applied to a frequency range of FR1.

For example, the RF requirement for the Type2 UE may be that the power imbalance requirement is only for the Type2 UE that reported this signaling, and when the power imbalance is x dB (e.g., 25 dB), under a specific received signal, the allowable sensitivity relaxation of the NR cell is a db (such as 1 dB), and the throughput should be ≥95%.

The effect of the UE reporting the first signaling may be: after the UE reports this signaling, the network node may know that this UE can support the non-collocated Intra-band CA deployment and therefore, it may perform the non-collocated Intra-band CA deployment to the UE, if the UE does not report this capability, the network node cannot perform the non-collocated Intra-band CA deployment to the UE.

Regarding the Second Signaling:

The second signaling may be designed to indicate that the UE supports the non-collocated Intra-band NRCA or the non-collocated Inter-band ENDC and meets the requirement for the Type3 or the Type4 UE (which may be replaced by the Type3/4 UE below). By way of example, the requirement for the Type3/4 UE may include a maximum receiving time difference (MRTD) requirement and/or a RF requirement for the Type3/4 UE. The RF requirement may include, for example, a requirement for the maximum number of Rx chains supported per cell; an intra-band blocking requirement (power imbalance, receiving reference sensitivity relaxation); a requirement for the maximum number of MIMO layers supported per cell; and a requirement for a frequency separation.

The Type3/4 UE has a stronger MIMO capability than the Type2 UE, for example, the Type 3 or Type 4 UE has a stronger MIMO capability than the Type 2 UE, which may include at least one of: each NR cell of the Type3/4 UE supporting more MIMO layers than each NR cell of the Type2 UE; each LTE cell of the Type3/4 UE supporting the same number of MIMO layers as each LTE cell of the Type2 UE; and each LTE cell of the Type3/4 UE supporting more MIMO layers than each LTE cell of the Type2 UE.

For example, the Type2 UE supports up to two MIMO layers per NR cell, the Type2 UE supports up to two MIMO layers per LTE cell, the Type3/4 UE supports up to four MIMO layers per NR cell, and the Type3/4 UE supports up to two or four MIMO layers per LTE cell.

The difference between the Type3 UE and the Type4 UE is that RF architectures implemented by the UEs are different. The UE behaviors and metrics requirement for the Type3 UE and the Type4 UE are the same, thus the Type3 and the Type4 are often written together in the full text.

It needs to be noted that the second signaling may be designed in a variety of ways, as long as it indicates the UE supports the non-collocated Intra-band NRCA or the non-collocated Inter-band ENDC and meets the requirement for the Type3/4 UE. For example, for the Type3/4 UE, the Inter-band ENDC and the Intra-band NRCA may also be designed with reference to the signaling of the Type2 UE.

For example, the second signaling may be designed as follows: if the UE reports this signaling, it indicates that the UE is the Type3/4 UE, and this signaling indicates that the intra-band CA of TDD or FDD supported by the UE, or the inter-band ENDC of FDD-FDD, TDD-TDD with band overlap or partial band overlap shall meet the MRTD requirement (MRTD<Y μs) indicated in 38.133 and the RF requirements for the Type3/4 UE. Here, Y is a preset value.

If the UE reports the second signaling, it is default that the UE also supports the non-collocated Intra-band NRCA or the non-collocated Inter-band ENDC for the Type2 UE, regardless of whether the UE reports the signaling indicated for the Type2 UE; if the UE does not report this second signaling, but reports a signaling indicating definition for the Type2 UE, it indicates that the UE is the Type2 UE, which indicates that the intra-band CA of TDD or FDD supported by the UE or the inter-band ENDC of FDD-FDD/TDD-TDD with band overlap or partial band overlap shall meet the MRTD requirement (MRTD<z μs) indicated in 38.133 and the RF requirements for the Type2 UE; if the UE does not report the second signaling, nor the signaling indicating the definition for the Type2 UE, it indicates that the UE is the Type1 UE, which indicates that the intra-band CA of FDD or TDD supported by the UE or the inter-band ENDC of FDD-FDD/TDD-TDD with band overlap or partial band overlap shall meet the MRTD requirement (MRTD<3 μs) indicated in 38.133 and the RF requirements for the Type1 UE.

The second signaling may be reported per band combination, is not mandatory (optional), and is applied to a frequency range of FR1.

The RF requirements for the Type3/4 UE are: the power imbalance requirement is only for the Type3/4 UE that reported the second signaling, when the power imbalance is y db, under a specific received signal, the allowable sensitivity relaxation for the NR cell or the LTE and NR cells is b dB, and the throughput should be ≥95%.

The effect of reporting the second signaling may be: after the UE reports the second signaling, the network node can know that this UE can support the non-collocated carrier aggregation deployment of DL MIMO with the enhanced capability, thus it can perform the non-collocated NRCA/ENDC deployment to this UE, if the UE does not report the enhanced capability, the network cannot perform the non-collocated NRCA/ENDC deployment of DL MIMO with the enhanced capability to this UE.

Regarding the Third Signaling:

Currently there exists a signaling that defines the maximum number of MIMO layers received per cell per band per band combination, however, it is shared for the collocated and non-collocated carrier aggregation, and can only report the maximum number of MIMO layers supported in the collocated and the non-collocated, so it is not clear, especially after the Type3/4 UE is introduced, it is more difficult to specify the maximum number of MIMO layers supported by each cell for the non-collocated deployment.

The present disclosure proposes to design the third signaling specifically for the non-collocated carrier aggregation to report the maximum number of MIMO layers per cell supported by the UE for non-collocated downlink reception.

For example, the third signaling defines the maximum number of downlink MIMO layers supported by the UE for the non-collocated carrier aggregation deployment. For a single cell (no CA) and a band with FR1 mandatory support of 4 receive chains, this signaling is mandatory and is required to report at least 4 MIMO layers, while at least 2 MIMO layers are supported for FR2. If this signaling is missing, the number of the non-collocated MIMO layers is referenced to a value reported by the signaling maxNumberMIMO-LayersPDSCH. If both this signaling and the signaling maxNumberMIMO-LayersPDSCH are missing, it indicates that the UE does not support MIMO on this carrier.

The third signaling may be reported per cell per band per band combination (FSPC), is conditional mandatory reporting (e.g., mandatory reporting for a single cell, mandatory or not mandatory (optional) reporting for the Type3/4 UE), and is applied to FR1 and FR2.

The FR1 denotes a range from 410 MHz to 7125 MHz. FR2 denotes 24250 MHz to 52600 MHz or above 52600 MHz. (In some releases, FR2 denotes 24250 MHz to 71000 MHz (e.g., FR 2-1 denotes 24.25 GHz to 52.6 GHz and FR 2-2 denotes 52.6 GHz to 71 GHz).

The effect of reporting the third signaling may be that the third signaling is deployed for the non-collocated and reports the maximum number of downlink MIMO layers that may be supported by each cc of the UE, which may be reported together with the first signaling or the second signaling, the network node can know how many DL MIMO layers are supported on each cc of the UE for the non-collocated carrier aggregation deployment through the third signaling, then the network node can configure the UE to work on different DL MIMO layers according to the actual working scenario, for example, for scenarios with low throughput requirement and low data transmission rate requirement, the network can configure the DL MIMO layers of the UE to be 2+2 layers (e.g., each NR cell supports up to two MIMO layers, each LTE cell supports up to two MIMO layers), while for scenarios requiring high-speed data transmission, the UE needs to be configured with 4+4 layers (e.g., each NR cell supports up to four MIMO layers, each LTE cell supports up to four MIMO layers) for transmission, or 2+4 layers (e.g., each LTE cell supports up to two MIMO layers and each NR cell supports up to four MIMO layers) for transmission.

Regarding the Fourth Signaling:

According to an embodiment, the fourth signaling may be designed to indicate the maximum number of receive chains supported by each cell of the UE for downlink reception. The fourth signaling is not limited to be specific to the non-collocated carrier aggregation, but may be a general IE. The fourth signaling may be designed in various ways, as long as it indicates the maximum number of receive chains supported by each cell of the UE for downlink reception. The fourth signaling is reported per cell (cc) per band per band combination (e.g., FSPC reporting), is not mandatory (optional), and may be applied only to the FR1, or to both the FR1 and the FR2.

The effect of reporting the fourth signaling may be that the network may better know the actual RF capability of the UE, especially when the fourth signaling is reported together with the first and second signaling, and if the third signaling is not reported but the fourth signaling is reported, the network can also know, to some extent, the actual number of DL MIMO layers supported by each cell in the non-collocated carrier aggregation, so that the network nodes may better perform the non-collocated carrier aggregation deployment for the UE. In addition, the fourth signaling may be used together with the capability signaling indicated for the Type1 UE for the network node to better perform the collocated carrier aggregation deployment. In addition, fourth signaling may be reported to the test equipment (TE) to facilitate testing.

Regarding the Fifth Signaling:

According to an embodiment, the fifth signaling may be indicated as indicating a category of a downlink frequency separation between cells supported by the UE. For example, the fifth signaling indicates a category of a downlink frequency separation between cells in the same band or between cells in different bands supported by the UE. The fifth signaling is applicable to downlink reception and is not limited to the non-collocated carrier aggregation, and is a general IE that may be used for both intra-band and inter-band. For example, the fifth signaling may be used for both intra-band non-contiguous NRCA of FDD/TDD, and inter-band ENDC/NEDC with frequency overlap and partial frequency overlap of FDD-FDD/TDD-TDD.

This signaling reports the category of the downlink frequency separation for the intra-band non-contiguous CA of FDD/TDD, or the inter-band ENDC/NEDC with frequency overlap or partial frequency overlap of FDD-FDD/TDD-TDD, the frequency separation is from the lowest frequency of the lowest frequency cell to the highest frequency of the highest frequency cell, e.g. including an aggregation bandwidth and a separation bandwidth, n categories of the frequency separation may be indicated, for example, as follows:
Category 1: non-contiguous CA separation≤100 MHz
Category 2: 100 MHz<non-CA separation≤200 MHz
Category 3: 200 MHz<non-contiguous CA separation<600 MHz
Category n: non-limited frequency separation (or without this category)

It should be noted that the above shown is only an exemplary way of defining the fifth signaling, the definition of the fifth signaling is not limited to the above example, as long as it may indicate the category of the downlink frequency separation between cells supported by the UE.

The fifth signaling may be reported per band combination, is not mandatory (optional) and is applicable to FR1.

The effect of reporting the fifth signaling may be: due to the limitation of the RF architecture, the downlink frequency separations of CA supported by different UEs are different, if the UE reports the DL frequency separation that it can support, the network can know the actual UE capability, for example, for DC_42_n77, when the UE reports the frequency separation between b42 and n77 that it can support is 200 MHz, the network may not configure DC_42_n77 with a frequency separation exceeding 200 MHz for the UE after the network knows the capability of the UE. If this capability is not reported by the fifth signaling, the network may configure CA/ENDC with a frequency separation that the UE cannot support for the UE, resulting in a waste of signaling resources. In addition, the fifth signaling may also be used together with the capability signaling indicated for the Type1 UE for the network node to better perform the collocated carrier aggregation deployment. Alternatively, the fifth signaling may also be reported in combination with any one or more of the above first signaling to the fourth signaling, such that the network node knows the carrier aggregation capability of the UE based on these signaling to better perform the non-collocated carrier aggregation deployment.

Regarding the Sixth Signaling:

Because uplink and downlink may support different frequency separations, the present disclosure designs separate signaling for uplink and downlink, with the fifth signaling for downlink and the sixth signaling for uplink.

According to an embodiment, the sixth signaling may be designed to indicate a category of an uplink frequency separation between cells supported by the UE. For example, the sixth signaling indicates a category of an uplink frequency separation between cells in different bands supported by the UE. As an example, the sixth signaling may be designed by referring to the signaling of the UL maximum frequency separation of the Intra-band CA above. The fifth signaling is applicable to uplink transmission and is not limited to the non-collocated carrier aggregation, but is a general IE, and it can be specific to the inter-band carrier aggregation, e.g., inter-band ENDC/NEDC.

For example, the sixth signaling may be designed as:

This signaling reports the category of the uplink frequency separation of inter-band ENDC/NEDC with frequency overlap or partial frequency overlap of FDD-FDD or TDD-TDD, the frequency separation is from the lowest frequency of the lowest frequency cell to the highest frequency of the highest frequency cell, e.g., including the aggregation bandwidth and the separation bandwidth, and n categories of the frequency separation may be indicated, e.g., as follows:
Category 1: inter-band ENDC/NEDC frequency separation with frequency overlap or partial frequency overlap≤100 MHz
Category 2: 100 MHz<inter-band ENDC/NEDC with frequency overlap or partial frequency overlap≤200 MHz
Category 3: 200 MHz<inter-band ENDC/NEDC with frequency overlap or partial frequency overlap<600 MHz
Category n: non-limited frequency separation (or without reporting this)

The sixth signaling may be reported per band combination, which is not mandatory (optional) and is applied to FR1.

The effect of reporting the sixth signaling may be: due to the limitation of the RF architecture, the uplink frequency separations of CA supported by different UEs are different, if the UE reports the uplink frequency separation that it can support, the network can know the actual UE capability, for example, for DC_42_n77, when the UE reports the frequency separation between b42 and n77 that it can support is 200 MHz, the network may not configure DC_42_n77 with a frequency separation exceeding 200 MHz for the UE after the network knows the capability of the UE. If this capability is not reported by the fifth signaling, the network may configure CA/ENDC with a frequency separation that the UE cannot support for the UE, resulting in a waste of signaling resources. In addition, the fifth signaling may also be used together with the capability signaling indicated for the Type1 UE for the network node to better perform the collocated carrier aggregation deployment. Alternatively, the sixth signaling may also be reported in combination with any one or more of the above first signaling to the fifth signaling, such that the network node knows the carrier aggregation capability of the UE based on these signaling to better perform the non-collocated carrier aggregation deployment.

As mentioned above, the capability information may include the first information and/or the second information. According to an embodiment, the second information may be used to indicate the type of carrier aggregation capability of the UE. For example, the type of the carrier aggregation capability may be indicated based on at least one of the followings:
the UE being a second type of UE and supporting intra-band New Radio (NR)carrier aggregation of non-collocated;
the UE being a third or fourth type of UE and supporting intra-band NR carrier aggregation of non-collocated or inter-band long term evolution technology-New Radio (LTE-NR) carrier aggregation of non-collocated, wherein the third or fourth type of UE has a stronger multiple-input multiple-output (MIMO) capability than the second type of UE;
a maximum number of MIMO layers per cell supported by the UE for non-collocated downlink reception;
a maximum number of receive chains per cell supported by the UE for downlink reception;
a category of a downlink frequency separation between cells supported by the UE;
a category of an uplink frequency separation between cells supported by the UE.

That is, according to an embodiment, optionally, the type of the carrier aggregation capability may be predefined according to what is indicated by at least one of the above first signaling to the sixth signaling. The UE may enable the network node to know the capability information of the UE by reporting the type of the carrier aggregation capability.

For example, the UE may not report the third signaling, the fourth signaling, the fifth signaling or the sixth signaling specifically, but may define the Type2 as a type of the carrier aggregation capability, the definition of this type may include content indicated by the first signaling, and may also optionally include at least one of: a definition of the maximum number of MIMO layers per cell supported by UE for non-collocated downlink reception (e.g. 2 layer per cc), a definition of the maximum number of receive chains per cell supported by the UE for downlink reception (e.g., 2 Rx Chain per cc), a definition of a category of a downlink frequency separation between cells supported by the UE (e.g., the supported category of the downlink frequency separation is a category X or no frequency separation limit), a definition of a category of a uplink frequency separation between cells supported by the UE (e.g., the supported category of the uplink frequency separation is a category Y or no frequency separation limit). For example, the definition of the category of the downlink frequency separation between cells supported by the UE includes a definition of a category of a downlink frequency separation between cells in the same band or between cells in different bands supported by the UE. For example, the definition of the category of the uplink frequency separation between cells supported by the UE includes a definition of a category of an uplink frequency separation between cells in the same band or between cells in different bands supported by the UE.

For another example, the UE may not report the third signaling, the fourth signaling, the fifth signaling or the sixth signaling via signaling specifically, but may define multiple Type3/4 as the type of the carrier aggregation capability, e.g., a Type3-1, a Type3-2, a Type3-3, a Type3-4, a Type4-1, a Type4-2, a Type4-3, a Type4-4, etc. For example, the definition of the Type3-1 may include, in addition to what is indicated by the second signaling, a definition of the maximum number of MIMO layers per cell supported by the UE for non-collocated downlink reception (e.g., 4 layer per cc for the NR cell, and 2 or 4 layer per cc for the LTE). For example, the definition of the Type3-1 may include, in addition to what is indicated by the second signaling, a definition of the maximum number of receive chains per cell supported by the UE for downlink reception (e.g., 2 or 4 Rx Chain per cc). For example, the definition of the Type3-1 may include, in addition to what is indicated by the second signaling, a definition of a category of a downlink frequency separation between cells supported by the UE (e.g., the supported category of the downlink frequency separation is a category X or no frequency separation limit). For example, the definition of the Type 3-1 may include, in addition to what is indicated by the second signaling, a definition of a category of an uplink frequency separation between cells supported by the UE (e.g. the supported category of the uplink frequency separation is Y or no frequency separation limit).

Similar to the Type 3-1, each of the Type 3-2, the Type 3-3, the Type 3-4, the Type 4-1, the Type 4-2, the Type 4-3, the Type 4-4 may include, in addition to what is indicated by the second signaling, a definition of at least one of: the maximum number of MIMO layers per cell supported by the UE for non-collocated downlink reception; the maximum number of receive chains per cell supported by the UE for downlink reception; a category of a downlink frequency separation between cells supported by the UE; and a category of an uplink frequency separation between cells supported by the UE. Due to the values of the maximum number of MIMO layers, the maximum number of receive chains, the category of the downlink frequency separation and/or the category of the uplink frequency separation included being different, a variety of Type3/4 may be indicated, such as a Type3-1, a Type3-2, a Type3-3, a Type3-4, a Type4-1, a Type4-2, a Type4-3 or a Type4-4.

As mentioned above in the description of the first signaling and the second signaling, the first signaling may indicate that the UE supports the non-collocated NR intra-band carrier aggregation and meets the requirement for a second type of UE, and the second signaling may indicate that the UE supports the non-collocated NR intra-band carrier aggregation or the non-collocated LTE-NR inter-band carrier aggregation and meets the requirement for a third type or a fourth type of UE, wherein the third type or the fourth type of UE can have a stronger MIMO capability than the second type of UE. For example, each Type3/4 UE here has a stronger MIMO capability than the Type2 UE.

The UE may only report the Type3-1, the Type3-2, the Type3-3, the Type3-4, the Type4-1, the Type4-2, the Type4-3 or the Type4-4 to the network node, for example, a possible IE form may be an IE with n bits, each bit from left to right indicates the Type3-1, the Type3-2, the Type3-2, the Type3-3, the Type3-4, the Type4-1, the Type4-2, the Type4-3 or the Type4-4 in sequence. If the UE support a certain type, the corresponding bit will be reported as 1. When the type is reported, for example, it may be reported per band combination and may be not mandatory (optional), and may be applied to FR1.

It should be noted that, although the Type2, the Type3-1, the Type3-2, the Type3-3, the Type3-4, the Type4-1, the Type4-2, the Type4-3, or the Type4-4 are listed above as an example, the type of the carrier aggregation capability that may be defined is not limited to the above nine types, but a variety types of the carrier aggregation capability may be defined depending on what is indicated by the first signaling to the sixth signaling above.

Since the number of DL MIMO layers, the category of the uplink/downlink frequency separation, and the maximum number of receive chains supported by the various types of the carrier aggregation capability (e.g., the Type 2, the Type 3-1, the Type 3-2, etc.) are already indicated, the network knows the actual capabilities of the UE after only the capability type is reported by the UE, thus facilitating the network node to perform the carrier aggregation deployment as needed. The specific effects of knowing the above various capability information have been described in the reported effects for the first signaling to the sixth signaling, and will not be repeated here.

At step S720, configuration information transmitted by the network node is received by the UE, wherein the configuration information includes at least one of: primary and/or secondary cell configuration of the UE; configuration to control the UE for carrier aggregation capability switching.

The primary cell (PCell) and/or secondary cell (SCell) configuration of the UE may be: only a SCell configuration or a PCell and SCell configuration. For example, when considering an ENDC scenario, the PCell configuration may refer to a primary secondary cell (PSCell) of a secondary cell group (SCG).

According to an embodiment, the receiving of the configuration information transmitted by the network node may include: receiving a first radio resource control (RRC) signaling for controlling the UE for carrier aggregation capability switching.

The effect of the first RRC signaling may be that the network node may directly inform the UE that the collocated or non-collocated condition of BS has changed, and based on the changed cell scenario, the network node may configure the UE to switch between different types of capabilities, for example, between Type1 and TypeY capabilities, wherein the TypeY capability may be, for example, a Type2 capability, a Type3 capability or a Type4 capability.

According to an embodiment, the first RRC signaling may include a first information element, the first information element is used to indicate that the UE shall be switched between a first type of capability and another type of capability; or, the first RRC signaling includes a second information element, the second information element is used to configure the primary and secondary cells have the same number of MIMO layers. As an example, the second information element may be an enhancement of an existing RRC signaling, for example, the second information element may be an enhancement of an existing IE, which may be ServingCellConfig.maxMIMO-Layers. Alternatively, the second information element may also be a new information element. For example, the first type of capability is a default capability indicated for the UE (e.g. a Type1 capability) and the another type of capability may be a second type of capability (e.g. a Type2 capability) or a third or fourth type of capability (e.g. a Type3/4 capability).

In the following, the design of the first RRC signaling is described in detail.

According to an embodiment, the first RRC signaling may be designed as the first information element, the first information element may be a new IE, the new IE may be NoncolocatedCA-Layers-r18, or the first RRC signaling may be designed as the second information element, the second information element may be an enhancement of an existing IE, the existing IE may be ServingCellConfig.maxMIMO-Layers.

For example, the first RRC signaling may be designed as the first information element with the effect that: it may explicitly indicate that the primary cell (PCell) and the SCell come from a collocated BS or a non-collocated BS and/or it shall explicitly indicate RF and Radio Resource Management (RRM) requirements in line with a UE of a Type Y capability, wherein the Type Y refers to one of the Type 2, Type 3, Type 4 capabilities.

According to an embodiment, the first information element may include a first coding bit, wherein when the first coding bit is a first value, it indicates that the UE is switched from the another type of capability to the first type of capability, and when the first coding bit is a second value, it indicates that the UE is switched from the first type of capability to the another type of capability. As mentioned above, first type of capability is a default capability indicated for the UE (e.g. the Type1 capability) and the another type of capability (e.g. the TypeY capability) may be the second type of capability (e.g. the Type2 capability) or the third type/type 4 of capability (e.g. the Type3/4 capability).

That is, the first information element may be designed as a 1-bit solution. This solution indicates that the network node configures the UE to switch between the Type1 capability and the Type Y capability based on the changed BS condition. It is coded as a 1-bit mapped field. For example, if the coding bit is a first value, the value may be “1” or “0”, which indicates that for that band combination, the UE should be switched from the Type Y capability to the Type1 capability, and the corresponding intra-band RF and RRM requirements, e.g., the Type1 UE requirement shall be used. If the coding bit is a second value, the value may be “1” or “0”, which indicates that for that band combination, the UE should be switched from the Type 1 capability to the Type Y capability, and the corresponding Type Y RF and RRM requirements shall be used.

Optionally, the first information element may be designed as another 1-bit solution. This solution directly indicates a change in the BS deployment conditions, the UE can configure itself to switch between the Type1 capability and the Type Y capability. It is coded as al-bit mapped field. For example, if the coding bit is a first value, the value may be either “1” or “0”, which indicates that for that band combination, the network deployment environment is switched from the non-collocated base station to the collocated base station and the UE should be switched from the Type Y capability to the Type 1 capability upon reception of the information and the corresponding intra-band RF and RRM requirements, e.g., the Type1 UE requirement shall be used. If the coding bit is a second value, the value may be “1” or “0”, which indicates that for that band combination, the network deployment environment is switched from the collocated base station to the non-collocated base station and accordingly the UE should be switched from the Type 1 capability to the Type Y capability upon reception of the information and the corresponding Type Y RF and RRM requirements shall be used.

Optionally, the first information element may also be designed as a multi-bit solution. This solution indicates that the network configures the UE to switch between the Type1 capability and the Type Y capability based on the BS condition being changed. This may be achieved by a multi-bit map design. For example, the design is coded as a 3-bit mapped field (e.g., including 3 coding bits). If the first information element is configured, it indicates that the UE is switched between different capabilities.

According to an embodiment, wherein the first information element includes a multiple coding bits, wherein a first coding bit of the multiple coding bits indicates whether a deployment of the network node is collocated or non-collocated; or, a second coding bit of the multiple coding bits indicates whether an operating assumption of the network node is a synchronous assumption or an asynchronous assumption; or, a third coding bit of the multiple coding bits indicates that a number of MIMO layers supported by each cell of the UE.

For example, the coded 3-bit mapping field may be designed as:

The leftmost or foremost is the first coding bit, the bit may indicate a deployment scenario, which may be non-collocated or collocated. If the first coding bit indicates a first value, the value may be “1” or “0”, which points out that the BS is currently in the non-collocated scenario; if the first coding bit indicates the second value, the value may be “1” or “0”, which points out that the BS is currently in the collocated scenario. The next bit is the second coding bit, which may indicate an operating assumption, and the operating assumption may be a synchronous assumption or asynchronous assumption. If the second coding bit indicates a first value, the value may be “1” or “0”, which points out that the BS is currently in the synchronous operating assumption; if the second coding bit indicates a second value, the value may be “1” or “0”, which points out that the BS is currently in the asynchronous operating assumption. The last bit is the third coding bit, which may indicate layer configuration, and the layer configuration may be two-layer configuration or four-layer configuration. If the third coding bit indicates a first value, the value may be “1” or “0”, which points out two-layer MIMO configuration per CC; if the third coding bit indicates a second value, the value may be “1” or “0”, which points out four-layer MIMO configuration per-CC.

For example, the multi-bit map may be designed as:

| 1 | 2 | 3 | . . . |
|---|---|---|---|
| C1 | C2 | C3 | |

When C1, C2, C3 are a third value, the third value may be 000, which indicates that for that band combination, the UE should support switching from the Type1 capability to the TypeY capability while using Type Y RF and RRM requirements. When C1, C2, C3 is a fourth value, the fourth value may be 101, which indicates that for that band combination, the UE should support switching from the TypeY capability to the Type1 capability while using Type 1 RF and RRM requirements.

The above describes the first RRC signaling being designed as the first information element, optionally, the first RRC signaling may also be designed as the second information element, for example, the second information element affects configuration of the primary cell and is used to arrange the primary and secondary cells to have the same number of MIMO layers. The effect of the second information element is to force the PCell and the SCell to have the same number of MIMO layers to solve the problem of the existing IE that only indicates the number of layers of the SCell but not the number of layers of the PCell when the BS scenario is changed. By forcing the PCell and the SCell to have the same number of MIMO layers, the UE may be indicated to switch capabilities by default.

Optionally, according to an embodiment, the wireless communication method performed by the user equipment shown in FIG. 7 may further include: performing capability switching of the UE according to the first RRC signaling; performing a behavior corresponding to a switched type of capability according to the type of capability. According to an embodiment, a first behavior includes a behavior of the UE under collocated carrier aggregation and a second behavior includes a behavior of the UE under non-collocated carrier aggregation.

According to an embodiment, the capability switching may include: the UE is switched from a first type of capability to a second type of capability, a third type of capability or a fourth type of capability; or, the UE is switched from the second type of capability, the third type of capability or the fourth type of capability to the first type of capability, wherein the first type of capability is a default capability indicated for the UE. Here, that the UE is switched from the first type of capability to the second type of capability, the third type of capability or the fourth type of capability may also be expressed as that the UE is switched from a first type of UE to a second type of UE, a third type of UE or a fourth type of UE. That the UE is switched from the second type of capability, the third type of capability or the fourth type of capability to the first type of capability may also be expressed as that the UE is switched from the second type of UE, the third type of UE or the fourth type of UE to the first type of UE.

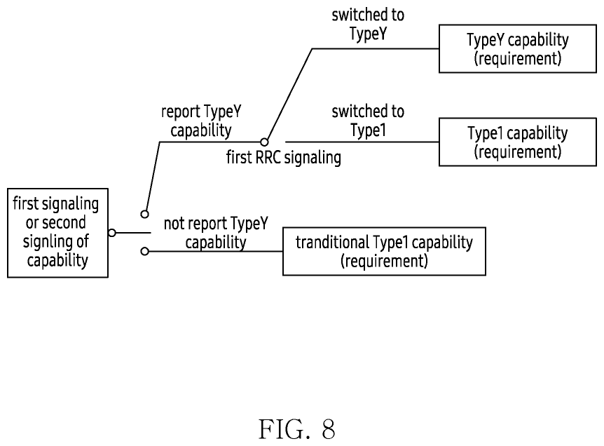

FIG. 8 is a schematic diagram of a user equipment performing capability switching according to an exemplary embodiment of the present disclosure.

According to an embodiment, the first RRC signaling may be received from the network node in a case that the UE reports a first signaling or a second signaling to the network node. Referring to FIG. 8, a precondition for the network node to transmit the first RRC signaling to the UE may be that the UE reports the first signaling or the second signaling. The UE reporting the first signaling or the second signaling indicates that the UE has the TypeY capability and the Type1 capability, such that the UE should be able to be switched between the Type1 capability and the TypeY capability. For example, it is switched between Type1-capability and TypeY-capability based on a request from the network node (e.g., base station (BS)). And if the UE does not report the first signaling or the second signaling, it indicates that the UE only has the Type1 capability. According to an embodiment, the first RRC signaling may only occur in cases where capability switching is required and may be disregarded in the initial RRC reconfiguration phase.

Meanwhile, when the UE receives the first RRC signaling after reporting the first signaling or the second signaling, the UE can be switched to the Type1 or the TypeY accordingly and should also meet the corresponding requirement. And when the UE does not report the first signaling or the second signaling, it should meet the requirement specific to the capability of the Type1 UE.

According to an embodiment, in the case that the UE reports the first signaling to the network node, the first RRC signaling may indicate that the UE is switched between the first type of capability and the second type of capability; in the case that the UE reports the second signaling to the network node, the first RRC signaling may indicate that the UE is switched between the first type of capability and the third type of capability or the fourth type of capability. According to an embodiment, the first type of capability (e.g. the Type1 capability) is a default capability indicated for the UE.

It is illustrated below by taking the capability of the Type2 UE and the capability of the Type1 UE as example that the UE is switched between the Type1 capability and the TypeY capability according to the first RRC signaling. In this example, it is assumed that the first RRC signaling follows the 1-bit solution design:

If the UE reports the first signaling to the network node:
If the network node knows that the cells of the two CCs are collocated:
   The network node configures and transmits the first RRC signaling and indicates the coding bit as the first value.
      At this time, the Type2 UE may know that it needs to be switched to the Type1 capability, while the corresponding Type1 requirement should be met.
   At the same time, the network node may configure collocated NR-CA downlink transmission.
      The non-collocated SCell is dropped; the new collocated SCell is added.
If the network node knows that the cells of the two CCs are non-collocated:
   The network node configures and transmits the first RRC signaling and indicates the coding bit as the second value.
      At this point, the Type1 UE may know that it needs to be switched to the Type2, while the corresponding Type2 requirement should be met.
   At the same time, the network configures non-collocated NR-CA downlink transmission.
      The collocated SCell is dropped; a new non-collocated SCell is added.

If the UE does not report the first signaling to the network:

The UE follows the Type1 capability.

According to an embodiment, a method to trigger the network node to configure and transmit the first RRC signaling may be designed as follows:

Network side triggering, e.g., the network node triggers the first RRC signaling based on the actual deployment condition (collocated or non-collocated). The benefits brought by the network side triggering method are simple, clear and straightforward, and do not increase the complexity of the UE.

UE side triggering, e.g., the UE may report its own sensed information to the network as assistance information to trigger the network node to transmit the first RRC signaling. The assistance information may be Receiving Time Difference (RTD) information. The benefit of the UE side triggering is that the method truly and accurately reflects the environment in which the UE is located. Based on the above analysis, the wireless communication method performed by the UE according to the embodiments has been described in conjunction with examples, since the UE can report to the network node the capability information regarding the carrier aggregation capability of the UE, the network node can fully know the carrier aggregation capability of the UE and transmits the configuration information to the UE accordingly, since the configuration information includes at least one of: the primary and/or secondary cell configuration of the UE; the configuration to control the UE for the carrier aggregation capability switching, a reasonable carrier aggregation deployment and/or dynamic capability switching of the UE can be achieved. A communication scenario to which the method shown in FIG. 7 is applied is exemplarily described below in connection with an optional embodiment.

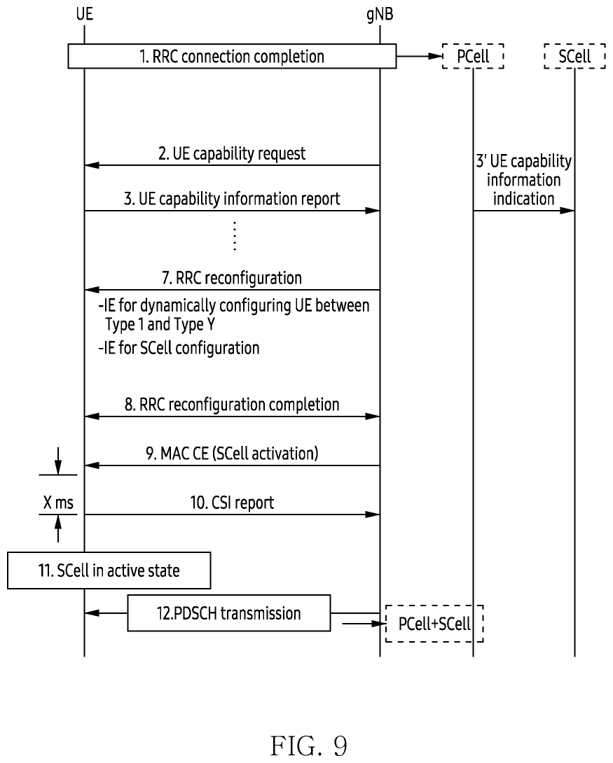

FIG. 9 illustrates an overall signal flow diagram for communication between the network node and the UE. In the example of FIG. 9, the UE may perform the wireless communication method performed by the UE described above. As shown in FIG. 9, the embodiment may include:

Step 1: The RRC connection is completed. At this time, the connection between the UE and the PCell is completed.

Step 2: The network node requests the UE to transmit the capability information, e.g. the network node transmits a “UECapabilityEnquiry” message to the UE.

Step 3: The UE reports the capability information to the network node based on the request of the network node, e.g., the UE reports a “UECapabilityInformation” message, to report its capability to the network node.

It should be noted that the UE may transmit to the network one or more of a first signaling (e.g., which indicates that for intra-band NR-CA, the UE supports the Type2 capability), a second signaling (e.g., which indicates that for intra-band NR-CA or inter-band EN-DC, the UE supports the Type3 or Type4 capability), a third signaling (e.g., which indicates MIMO layer number capability configuration for non-collocated deployment), a fourth signaling (e.g., which indicates Rx Chain number configuration capability), a fifth signaling (e.g., which indicates downlink frequency separation capability for intra-band NR-CA or inter-band EN-DC with overlapping band), a sixth signaling (e.g., which indicates uplink frequency separation capability for intra-band NR-CA or inter-band EN-DC with overlapping band), based on its capability. If the UE reports the first signaling or the second signaling to the network, it indicates that the UE is a UE with a high capability.

Step 7: the RRC reconfiguration phase. The network node may perform configuring based on the capability information reported by the UE. It should be noted that 1) the steps omitted between Step 3 and Step 7 are: Step 4: the RRC re-establishment request; Step 5: the RRC reconfiguration; and Step 6: the RRC reconfiguration completion. In FIG. 9 they are omitted. 2) when the UE reports the first signaling or the second signaling, the network node may configure and transmit the first RRC signaling to the UE, this signaling may be used by the network node to directly inform the UE that its current collocated and non-collocated environment has changed and dynamically configure the UE to be dynamically switched between the Type1 and the TypeY. Specifically, the first RRC signaling indicates that the UE is dynamically switched between the Type1 and the Type2 when the UE reports the first signaling of the capability, and the first RRC signaling indicates that the UE is dynamically switched between the Type1 and the Type3 when the UE reports the second signaling of the capability. 3) The role of the SCell configuration IE is used for the UE to inform the network node whether it supports the carrier aggregation capability.

Step 8: the RRC reconfiguration completion phase.

Step 9: the SCell activation using the Medium Access Control Control Element (MAC CE).

Step 10: the Channel State Information (CSI) reporting phase.

Step 11: the SCell is the activation phase.

Step 12: the PCell and the SCell start data transmission.

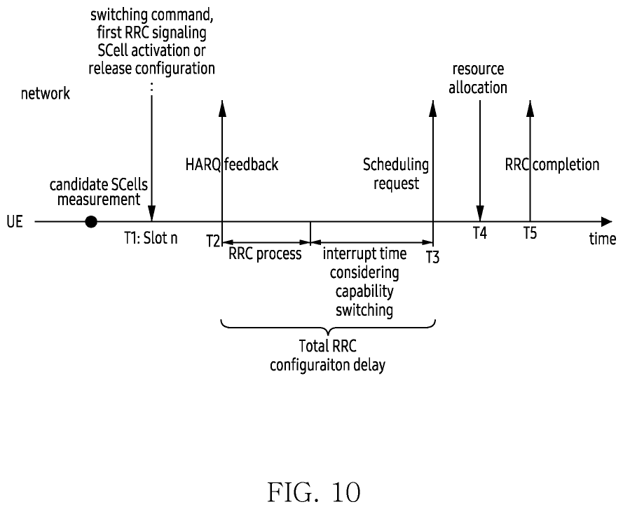

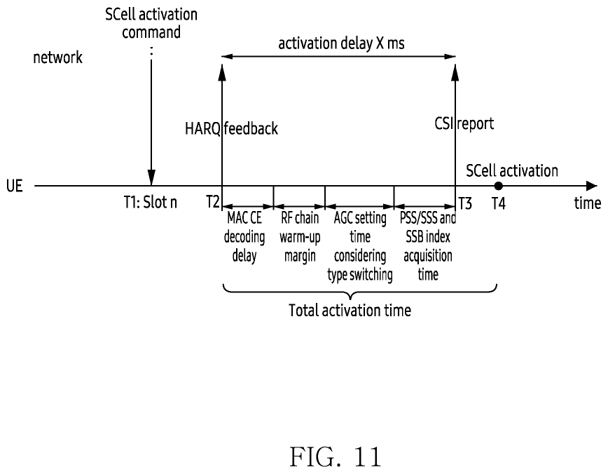

It needs to be noted that in the aspect of the RRC reconfiguration, new impacts for the UE behavior would be brought due to considering the capacity switching, e.g., due to the introduction of the capacity switching, the UE reports a first RRC signaling configuration completion indication will occur an additional delay (specific details will be illustrated in conjunction with FIG. 10). Furthermore, in the aspect of the SCell activation, new impacts for the UE behavior would be brought due to considering the capability switching action, e.g., due to the introduction of the capability switching, the UE needs to define a new behavior during the SCell activation phase and the delay between Step 9 and Step 10 increases (details will be illustrated in conjunction with FIG. 11).

Next, that new impacts for the UE behavior would be brought due to considering the capacity switching in the aspect of the RRC reconfiguration and new impacts for the UE behavior would be brought due to considering the capacity switching in the aspect of the SCell activation will be described with reference to FIG. 10 and FIG. 11, respectively.

FIG. 10 is a schematic diagram of when the UE reports the first RRC signaling configuration completion indication (RRC configuration delay) after the introduction of the capability switching according to an exemplary embodiment of the present disclosure.

The UE may report the first RRC signaling configuration completion indication to the network node after the RRC reconfiguration is complete. Thus, optionally, the wireless communication method performed by the UE shown in FIG. 7 may further include: after performing capability switching, UE reports a first RRC signaling configuration completion indication to the network node, wherein a time for reporting the first RRC signaling configuration completion indication is related to an RRC configuration delay caused by the capability switching.

According to an embodiment, the time components involved in the RRC reconfiguration and the corresponding definitions are shown in Table 2 below:

| time component | definition |
|---|---|
| T_{RRC}_{_{—}}_{Pro} | RRC process delay |
| | 1) RRC reconfiguration (SCell addition or |
| | release): 16 ms |
| | 2) RRC reconfiguration (collocated): 10 ms |
| T_{HARQ} | Timing between downlink data transmission |
| | and uplink acknowledgement |
| Tᵢₙₜₑᵣᵣᵤₚₜ | Interruption time for the SCell addition or |
| | release |

According to an embodiment, the value of the RRC configuration delay may be determined based on a first interruption time, wherein the first interruption time is determined based on a first preparation time associated with the capability switching and/or a type of the capability switching.

Considering the capability switching, the first preparation time may additionally be increased, the first preparation time may be expressed as Tₚᵣₑₚₐᵣₑ, for example, the first preparation time may include a second impact parameter or/and a third impact parameter, the second impact parameter and the third impact parameter may be a RF hardware preparation time or transition time required to perform the capability switching.

Considering the capability switching, the existing interruption time for SCell addition or release is denoted as Tᵢₙₜₑᵣᵣᵤₚₜ, it may be enhanced as the first interruption time, and the first interruption time may be denoted as T_{interrupt_switch}, which may be indicated as Tᵢₙₜₑᵣᵣᵤₚₜ_switch=Tᵢₙₜₑᵣᵣᵤₚₜ+Tₚᵣₑₚₐᵣₑ.

Then considering T_{interrupt_switch} and based on T_{HARQ}, for example, the total RRC configuration delay may be expressed as:

T_{Switch}=Slot n+T_{HARQ}+T_{RRC_Pro}+T_{interrupt_switch}

Optionally, the length of the first interruption time T_{interrupt_switch} is related to the type of the capability switching of the UE discussed above, besides of the first preparation time Tₚᵣₑₚₐᵣₑ. According to an embodiment, the type of the capability switching includes:

The UE is switched from the first type of capability to the second type of capability, the third type of capability or the fourth type of capability;

The UE is switched from the second type of capability, the third type of capability or the fourth type of capability to the first type of capability,

Where the first type of capability (e.g. the Type 1 capability) is a default capability indicated for the UE.

Depending on different types of the capability switching, the ways of calculating the first interruption time based on Tₚᵣₑₚₐᵣₑ are different, which ultimately leads to different first interruption times.

At the same time, an applicable condition of the RRC configuration delay may be determined based on the capability information reported by the UE and/or the first RRC signaling. For example, new and different applicable condition may be indicated for different first interruption times due to the introduction of the capability switching, the applicable conditions may be determined based on the capability information reported by the UE and/or the first RRC signaling.

In the following, the new impacts for the UE in the aspect of the RRC reconfiguration due to the capability switching is exemplarily described by using the switching between the Type 2 capability and the Type 1 capability as example:

When a SCell of a Secondary Cell Group (SCG) is added or released:

The UE would know to switch to the Type2 capability;

The UE is allowed an interruption on any active serving cell in SCG:
of up to X1 slot+Tₚᵣₑₚₐᵣₑ, if UE is capable of the first signaling (which may be intraBandNRCA-NonCollocated-r18) or if the active serving cells are non-contiguous to any of the SCells being added or released in the same FR1 band and the network node sends the first RRC signaling (which may be NoncolocatedCA-Layers-r18) with the field is set to “the second value” (e.g., indicating that the type of the capability switching is that the UE is switched from the Type1 capability to the Type2 capability) during the RRC reconfiguration phase.

The UE would know to switch to the Type1 capability;

The UE is allowed an interruption on any active serving cell in SCG: of up to Y1 slot+T_{SMTC_duration}+Tₚᵣₑₚₐᵣₑ, if the active serving cells are in the same FR1 band as any of the SCells being added or released and UE is capable of the first signaling (which may be intraBandNRCA-NonCollocated-r18) and the network node sends the first RRC signaling (which may be NoncolocatedCA-Layers-r18) with the field is set to “the first value” (e.g., indicating that the type of the capability switching is that the UE is switched from the Type2 capability to the Type1 capability) during the RRC reconfiguration phase.

The UE is allowed an interruption on any active serving cell in SCG: of up to Y1 slot+T_{SMTC_duration}+Tₚᵣₑₚₐᵣₑ if the active serving cells are in the same FR1 band as any of the SCells being added or released and if the UE is not capable of first signaling (which may be intraBandNRCA-NonCollocated-r18),

Where T_{SMTC_duration} is the longest SMTC duration among all above active serving cells in SCG and the SCell being added when one SCell is added

When one Evolved Universal Terrestrial Radio Access (E-UTRA) SCell in Master Cell Group (MCG) is added or released:

The UE would know to switch to the Type2 capability;

The UE is allowed an interruption on any active serving cell in SCG: of up to X1 slot+Tₚᵣₑₚₐᵣₑ, if the active serving cell is not in the same band as any of the E-UTRA SCells being added or released and if the UE is capable of first signaling of the capability (which may be intraBandNRCA-NonCollocated-r18) and the network node sends the first RRC signaling (which may be NoncolocatedCA-Layers-r18) with the field is set to “the second value” (e.g., indicating that the type of the capability switching is that the UE is switched from the first type of capability to the second type of capability) during the RRC reconfiguration phase.

The UE would know to switch to the Type1 capability;

The UE is allowed an interruption on any active serving cell in SCG: of up to max{Y1 slot+T_{SMTC_duration}+Tₚᵣₑₚₐᵣₑ, 5 ms}, if the active serving cells are in the same band as any of the E-UTRA SCells being added or release and if the UE is capable of first signaling of the capability (which may be intraBandNRCA-NonCollocated-r18) and the network node sends the first RRC signaling (which may be NoncolocatedCA-Layers-r18) with the field is set to “the first value”

The UE is allowed an interruption on any active serving cell in SCG: of up to max {Y1 slot+T_{SMTC_duration}+Tₚᵣₑₚₐᵣₑ, 5 ms}, if the UE is not capable of first signaling of the capability (which may be intraBandNRCA-NonCollocated-r18) and if the active serving cells are in the same band as any of the E-UTRA SCells being added or released.
where T_{SMTC_duration} is the longest SMTC duration among all above active serving cells in SCG,
where X1, Y1 are specified in table 8.2.1.2.3-2 of TS 38.133 V18.1.0 version when one SCell in SCG is added or released, and X1, Y1 are specified the table 8.2.1.2.3-2 of TS 38.133 V18.1.0 version when one E-UTRA SCell in MCG is added or released, as follows:

TABLE 8.2.1.2.3-1
Interruption length X1 and Y1 at E-UTRA SCell addition/Release

| | NR Slot | Interruption length X1 | | Interruption length Y1 | |
|---|---|---|---|---|---|
| | length | (slots) | | (slots) | |
| μ | (ms) | Sync | Async | Sync | Async |
| 0 | 1 | 1 | 2 | 1 | 2 |
| 1 | 0.5 | 2 | 3 | 2 | 3 |

| | | | | |
|---|---|---|---|---|
| 2 | 0.25 | 5 | 4 | 5 |
| 3 | 0.125 | 9 | N/A | - N/A |

TABLE 8.2.1.2.3-2
Interruption length X1 and Y1 at SCell addition/Release

| | NR Slot | | | |
|---|---|---|---|---|
| | length (ms) | Interruption | | Interruption |
| | of victim | length X1 | | length Y1 |
| μ | cell | (slots) | | (slots) |
| 0 | 1 | 1 | | 1 |
| 1 | 0.5 | 2 | | 2 |
| 2 | 0.25 | Both aggressor cell and | 4 | 4 |
| | | victim cell are on FR2 | | |
| | | Either aggressor cell or | 5 | |
| | | victim cell is on FR1 | | |
| 3 | 0.125 | Aggressor cell is on FR2 | 8 | 8 |
| | | Aggressor cell is on FR1 | 9 | |

FIG. 11 is a schematic diagram of SCell activation after considering a capacity switching behavior according to an exemplary embodiment of the present disclosure. Referring to FIG. 11 illustrates new impacts for the UE behavior brought due to considering the capability switching action in the aspect of the SCell activation.

The UE may perform secondary cell activation after the RRC reconfiguration is completed. Thus, optionally, the wireless communication method performed by the UE shown in FIG. 7 may further include: performing secondary cell activation when a secondary cell activation command is received from the network node, wherein a time of the secondary cell activation is related to an activation delay caused by the capability switching.

According to an embodiment, the time components involved in the SCell activation and the corresponding definitions are shown in Table 3 below:

| time component | definition |
|---|---|
| T_{activation}_{_{—}}ₜᵢₘₑ | SCell activation time, with different |
| | activation times for different types |
| T_{index}_{_{—}}_{acquiring} | PSS/SSS and SSB index acquiring including |
| | the longer SMTC periodicity between active |
| | serving cells and SCell being activated |
| | T_{SMTC}_{_{—}}_{MAX} |
| T_{CSI}_{_{—}}_{reporting} | The delay uncertainty in acquiring the first |
| | available CSI reporting, specified in TS |
| | 38.331 |
| T_{AGC setting} | AGC setting time |
| T_{MAC-CE} | MAC-CE process time |
| T_{RF-warmup} | RF chain warm-up time |

According to an embodiment, the value of the activation delay may be determined based on a first activation time, wherein the first activation time is determined based on the adjustment time associated with the capability switching and/or the type of the capability switching. For example, the first activation time is determined based on a first AGC setting time and a first index acquisition time, wherein the first AGC setting time is determined based on the adjustment time associated with the capability switching, and the first index acquisition time is determined based on the SMTC period, wherein the SMTC period is indicated based on the type of the capability switching. For example, the adjustment time associated with the capability switching may include a first AGC adjustment time and a first other adjustment time. Further, according to an embodiment, an applicable condition of the activation delay is determined based on the capability information reported by the UE and/or the first RRC signaling.

For example, considering the capability switching, the first AGC adjustment time and the first other adjustment time may be additionally increased. Wherein, the first AGC adjustment time indicates an adjustment time of the RF front-end, which may be expressed as T_{AGC_adjustment}, and the first other adjustment time may be a baseband adjustment delay, which may be denoted as Tₒₜₕₑᵣₛ.

For example, considering the capability switching, the AGC setting time may be enhanced to the first AGC setting time, denoted as T_{AGCsetting_switching}. It may include the following components: T_{AGCsetting}, the first AGC adjustment time T_{AGC_adjustment}, and the first other adjustment time Tₒₜₕₑᵣₛ, which may be indicated as:

T_{AGCsetting_switching}=T_{AGCsetting}+T_{AGC_adjustment} Tₒₜₕₑᵣₛ

For example, considering the switching capability, the longer SMTC period T_{SMTC_MAX} will be limited for different applicable condition, and the value will be different under the different applicable conditions, and the PSS/SSS and SSB index acquisition time T_{index_acquiring} is another parameter related to T_{SMTC_MAX}, therefore, it may be enhanced to the first index acquiring time T_{indexacquiringswitch}.

For example, considering the capability switching, the activation time may be enhanced to the first activation time, denoted as T_{activation_switch_time}, which may include the following components: T_{MAC-CE}, T_{RF-warmup}, the first AGC setting time T_{AGCsetting_switching}, and the first index acquisition time T_{index_acquiring_switch}, for example, the first activation time may be indicated as:

T_{activation_switch_time}=T_{MAC-CE}+T_{RF-warmup}+T_{AGCsetting_switching}(T_{AGC_adjustment},Tₒₜₕₑᵣₛ)+T_{index_acquiring_switch}(T_{SMTC_MAX})

As a result, the total activation delay may be enhanced to the first activation delay, which may be denoted as T_{switch_type}, and may include the following components: the timing between downlink data transmission and uplink acknowledgement T_{HARQ}, the first activation time T_{activation_switch_time} and T_{CSI_reporting}. T_{Switch_type} may be indicated as

T_{Switch_type}=Slot n+T_{HARQ}+T_{activation_switch_time}+T_{CSI_reporting}

In the following, the first AGC adjustment time, the first other adjustment time and the first activation time are further explained.

The first AGC adjustment time T_{AGC_adjustment} and the first other adjustment time Tₒₜₕₑᵣₛ may be combined and collectively referred to as an additional adjustment delay. The additional adjustment delay is caused primarily by, for example, the AGC gain mode change including the RF front-end adjustment and the baseband adjustment as well as other adjustment delay(s).

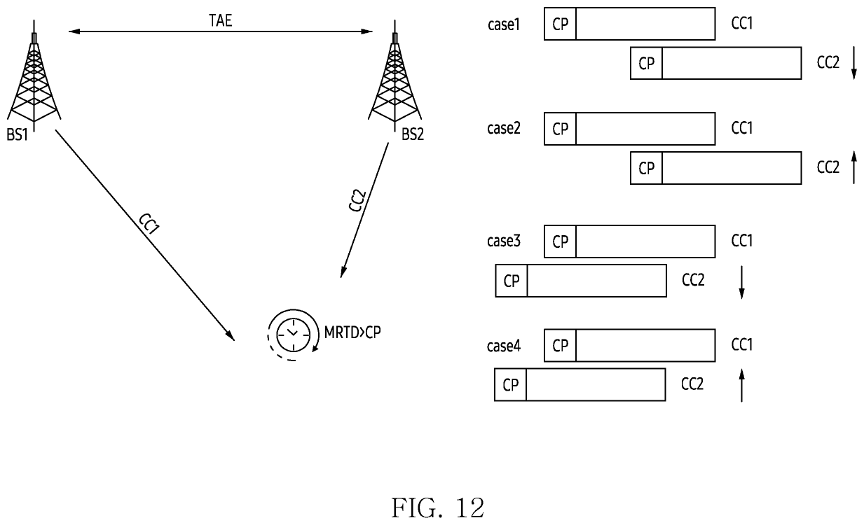

FIG. 12 is a schematic diagram of AGC adjustment after considering a capability switching behavior according to an exemplary embodiment of the present disclosure. Referring to FIG. 12 illustrates different cases of AGC adjustment and restrictions on the value of the first adjustment time, when switching between the Type1 and the TypeY.

Different input signals have different strengths, and the AGC needs to be adjusted according to the strengths of the different input signals. Then when switching from the Type1 to the TypeY, the AGC adjustment will produce different cases.
Case 1: Low level of signal arrives late; Case 2: High level of signal arrives late; Case 3: Low level of signal arrives early; Case 4: High level of signal arrives early.

Based on these complex cases, especially when MRTD>CP, for a useful signal on another CC, it will cause a degradation of decoding performance. The reason is that AGC gain switching may only be aligned with a time slot boundary of one of the CCs, so in the case of MRTD>CP, the AGC gain change will happen during the useful symbol on the other CC distorting the received signal, resulting in the degradation of decoding performance.

At the same time, although the AGC design depends on the UE implementation, its delay value Yμs is constrained. This is because the SCell activation time is a function of the first AGC adjustment time T_{AGC_adjustment} and an increase in T_{AGC_adjustment} leads to an increase in the total activation time, which in turn leads to an offsetting system resource utilization.

Regarding the first other adjustment time Tₒₜₕₑᵣₛ This value includes FFT window changes, additional circuit modules on/off, etc. For example, when switching from the Type1 to the TypeY, depending on different UE reception designs, there may be a shift from 4 layer/4RX chain per cc to 2 layer/2RX chain per cc, with every two Rx Chians being connected, directly or indirectly, to separate AGC module and ADC module respectively, at this time the additional circuit module may be turned on; and when switching from the TypeY to the Type 1, depending on the different UE acceptance designs, there may be a shift from 4 layer/4RX chain per cc to 2 layer/2RX chain per cc, with 4RX chain being connected, directly or indirectly, to an AGC module and ADC module, at this time the additional circuit module may be turned off. Each “module” herein may comprise circuitry

Regarding the first activation time T_{activation_switch_time}. Considering the above analysis of each impact parameter, in the non-collocated FR1 intra-band non-contiguous carrier aggregation scenario, the new impacts on the UE behavior by considering the capability switching action in the aspect of the SCell activation may be especially reflected in the activation in the case that the SCell is unknown. For example, if the SCell is unknown and belongs to FR1, SCell activation delay may be indicated separately as:

For example, if the semi-persistent Channel State Information-Reference Signal (CSI-RS) is used for CSI reporting, the SCell activation delay may be:

6ms+T_{FirstSSB_MAX}+T_{SMTC_MAX}+Trs+T_{L1-RSRP,measure}+T_{L1-RSRP,report}+T_{HARQ}+T_{AGC_adjustment}+Tₒₜₕₑᵣₛ+max(T_{uncertainty_MAC}+T_{FineTiming}+2ms,T_{uncertainty_SP}).

For example, if the periodic CSI-RS is used for CSI reporting, the SCell activation delay may be:

3ms+T_{FirstSSB_MAX}+T_{SMTC_MAX}+Trs+T_{L1-RSRP,measure}+T_{L1-RSRP,report}+max(T_{HARQ}+T_{uncertainty_MAC}+5ms+T_{FineTiming},T_{uncertainty_RRC}+T_{RRC_delay}+T_{AGC_adjustment}+Tₒₜₕₑᵣₛ).

Wherein the SMTC period may be indicated according to the type of the capability switching performed by the UE, in case of considering the capability switching. According to an embodiment, the type of the capability switching includes:
the UE is switched from the first type of capability to the second type of capability, the third type of capability or the fourth type of capability;
the UE is switched from the second type capability, the third type capability or the fourth type capability to the first type capability.

Wherein the first type of capability (e.g. the Type 1 capability) is a default capability indicated for the UE.

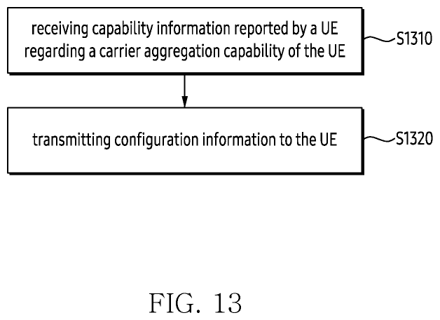

For example, T_{SMTC_MAX} may be reindicated as follows:
1) in case of intra-band non-contiguous SCell activation where the UE is capable of the first signaling or the second signaling of the capability, and if the network node sends the first RRC signaling (which may be intraBandNRCA-NonCollocated-r18) with field is set to” the second value” (e.g., indicating that the type of the capability switching is that the UE is switched from the first type of capability to the second type of capability or the third type of capability), T_{SMTC_MAX} is indicated as a SMTC period of the Scell being activated.
2) in the case of intra-band non-contiguous SCell activation where the UE is capable of reporting the first signaling or the second signaling of the capability, and if the network node sends the first RRC signaling (which may be intraBandNRCA-NonCollocated-r18) to the UE during the RRC reconfiguration phase with the field is set to “first value” (e.g., indicating that the type of the capability switching is that the UE is switched from the second type of capability or the third type of capability to the first type of capability), T_{SMTC_MAX} may be redefined as a longer SMTC periodicity between active serving cells and SCell being activated. The wireless communication method performed by the UE has already been described above, a wireless communication method performed by the network node is described with reference to FIG. 13 below.

FIG. 13 is a flowchart of a wireless communication method performed by a network node according to an exemplary embodiment of the present disclosure.

At step S1310, capability information reported by a UE regarding a carrier aggregation capability of the UE is received. According to an embodiment, the capability information may include first information and/or second information, the first information is a signaling for indicating the carrier aggregation capability supported by the UE and the second information is used to indicate a type of the carrier aggregation capability of the UE. According to an embodiment, the first information may include at least one of: a first signaling indicating that the UE supports intra-band New Radio (NR) carrier aggregation of non-collocated and meets a requirement for a second type of UE; a second signaling indicating that the UE supports intra-band NR carrier aggregation of non-collocated or inter-band long-term evolution technology-New Radio (LTE-NR) carrier aggregation of non-collocated and meets a requirement for a third or fourth type of UE, wherein the third or fourth type of UE has a stronger multiple-input multiple-output (MIMO) capability than the second type of UE; a third signaling indicating a maximum number of MIMO layers per cell supported by the UE for non-collocated downlink reception; a fourth signaling indicating a maximum number of receive chains per cell supported by the UE for downlink reception; a fifth signaling indicating a category of a downlink frequency separation between cells supported by the UE; a sixth signaling indicating a category of an uplink frequency separation between cells supported by the UE.

Further, according to an embodiment, the type of the carrier aggregation capability may be indicated based on at least one of: the UE being a second type of UE and supporting intra-band New Radio (NR)carrier aggregation of non-collocated; the UE being a third or fourth type of UE and supporting intra-band NR carrier aggregation of non-collocated or inter-band long term evolution technology-New Radio (LTE-NR) carrier aggregation of non-collocated, wherein the third or fourth type of UE has a stronger multiple-input multiple-output (MIMO) capability than the second type of UE; a maximum number of MIMO layers per cell supported by the UE for non-collocated downlink reception; a maximum number of receive chains per cell supported by the UE for downlink reception; a category of a downlink frequency separation between cells supported by the UE; category of an uplink frequency separation between cells supported by the UE.

Since the various signaling and types of the carrier aggregation capability have already been described above, they are not repeated here. All relevant details may be found in the corresponding section above.

Next, at step S1320, configuration information is transmitted to the UE according to the received capability information, wherein the configuration information includes at least one of: primary and/or a secondary cell configuration for the UE; configuration to control the UE for carrier aggregation capability switching.

The transmitting of the primary and/or secondary cell configuration to the UE is one of the operations to implement the carrier aggregation deployment of the UE. As an example, in a case where the UE is a second type of UE and supports intra-band NR carrier aggregation of non-collocated, the first information includes at least a first signaling; and/or, in a case where the UE is a third or fourth type of UE and supports intra-band NR carrier aggregation of non-collocated or inter-band LTE-NR carrier aggregation of non-collocated, the first information includes at least a second signaling. In the both cases, the network node may perform the non-collocated carrier aggregation deployment to the UE based on the received capability information. However, the network node is not limited to only being able to perform the non-collocated carrier aggregation deployment to the UE, for example, depending on the signaling included in the first information, a collocated carrier aggregation deployment to the UE may also be performed.

According to an embodiment, the transmitting of the configuration information to the UE in S1320 may include: transmitting a first radio resource control (RRC) signaling to the UE for controlling the UE for carrier aggregation capability switching.

According to an embodiment, the first RRC signaling includes a first information element, the first information element is used to indicate that the UE is switched between a first type of capability and another type of capability; or, the first RRC signaling includes a second information element, the second information element is used to configure the primary and secondary cells to have the same number of MIMO layers.

As an example, the first information element includes a first coding bit, wherein when the first coding bit is a first value, it indicates that the UE is switched from the another type of capability to the first type of capability; and when the first coding bit is a second value, it indicates that the UE is switched from the first type of capability to the another type of capability.

Optionally, the first information element includes multiple coding bits, wherein a first coding bit of the multiple coding bits indicates that a deployment of the network node is collocated or non-collocated; or, a second coding bit of the multiple coding bits indicates that an operating assumption of the network node is a synchronous assumption or an asynchronous assumption; or, a third coding bit of the multiple coding bits indicates a number of MIMO layers supported by each cell of the UE.

According to an embodiment, the first RRC signaling is used to control the UE for capability switching. For example, the capability switching may include:

The UE is switched from a first type of capability to a second type of capability, a third type of capability or a fourth type of capability; or

The UE is switched from the second type of capability, the third type of capability or the fourth type of capability to the first type of capability, wherein the first type of capability is a default capability indicated for the UE,

Wherein the first type capability is a default capability indicated for the UE.

Here, that the UE is switched from the first type of capability to the second type of capability, the third type of capability or the fourth type of capability may also be expressed as that the UE is switched from a first type of UE to a second type of UE, a third type of UE or a fourth type of UE. That the UE is switched from the second type of capability, the third type of capability or the fourth type of capability to the first type of capability may also be expressed as that the UE is switched from the second type of UE, the third type of UE or the fourth type of UE to the first type of UE.

According to an embodiment, the first RRC signaling is transmitted to the UE in the case that a first signaling or a second signaling is received from the UE, wherein the first RRC signaling indicates that the UE is switched between the first type of capability and the second type of capability, in the case that the first signaling is received from the UE; wherein, the first RRC signaling indicates that the UE is switched between the first type of capability and a third or fourth type of capability, in the case that the second signaling is received from the UE; wherein the first type of capability is a default capability indicated for the UE.

In the above, the first RRC signaling and the capability switching and other relevant contents have been described in the description of the wireless communication method performed by the UE, therefore, these contents will not be repeated in the description of the wireless communication method performed by the network side, the details of which may be found in the corresponding contents above.

Above, the wireless communication method performed by the UE and the wireless communication method performed by the network node according to the example embodiments have been described with reference to the accompanying drawings, and according to the above wireless communication methods, since the network node receives the capability information reported by the UE regarding the carrier aggregation capability of the UE, the network node can fully know the capability of the UE and transmits the configuration information to the UE according to the received capability information, and configuration information includes at least one of the primary and/or secondary cell configuration of the UE and the configuration to control the UE for carrier aggregation capability switching, thus, according to the above wireless communication methods, the primary and/or secondary cell configuration may be performed more rationally, thereby implementing a rational carrier aggregation deployment, and dynamic switching between UE capabilities may be implemented when the network side condition is changed, for example, backward compatibility of the TypeY requirement may be implemented, which also leads to the following benefits, taking switching from the Type2 to the Type1 as an example:

4-layer MIMO leads to a significant improvement in system throughput performance; Data demodulation accuracy is guaranteed with MRTD<CP; the UE can receive data from the same BS that performs the measurement while taking into account scheduling availability; and an efficient utilization of spectrum resources.

In the following, the UE and the network node are briefly described.

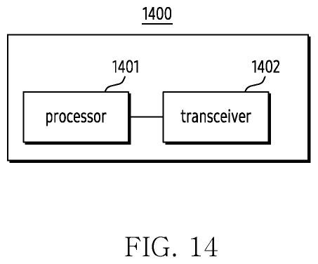

FIG. 14 illustrates a block diagram of a user equipment according to an exemplary embodiment of the present disclosure.

Referring to FIG. 14, the user equipment 1400 may include at least one processor 1401 and a transceiver 1402. Specifically, the at least one processor 1401 is coupled, directly or indirectly, to the transceiver 1402 and is configured to perform the wireless communication method referred to in the above description regarding FIG. 7. Details of the operations involved in the above wireless communication method may be found in the description of FIG. 7, and none of them will be repeated here.

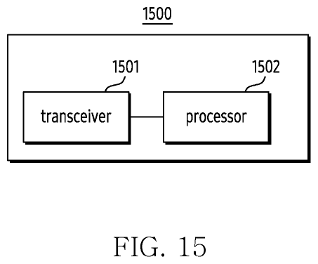

FIG. 15 illustrates a block diagram of a network node according to an exemplary embodiment of the present disclosure.

Referring to FIG. 15, the network node 1500 may include a transceiver 1501 and at least one processor 1502. Specifically, the at least one processor 1502 is coupled, directly or indirectly, to the transceiver 1501 and is configured to perform the wireless communication method referred to in the above description regarding FIG. 13. Details of the operations involved in the above wireless communication method may be found in the description of FIG. 7 and FIG. 13, and none of them will be repeated here.

Embodiments of the disclosure are targeted for intra-band CA non-collocated deployment and inter-band EN-DC with overlapping spectrum non-collocated deployment. Allow UE to indicate the non-collocated related capabilities including non-collocated capability type, MIMO layer, Rx Chain numbers and frequency separation, as well as allow NW to configure UE to switch between different UE capabilities when the BS(NW) scenario is changed from collocated to non-collocated or from non-collocated to collocated, and accordingly the UE requirements and UE behaviors are also switched.

The subjects of the embodiments are shown as below:
Subject #1: UE capability static report
Introduce six UE capability and corresponding static indication
Otherwise, NW is not able to configure EN-DC or NR-CA operation with desired function for non-collocated deployment
Subject #2: NW controls a UE dynamic switching
NW tell UE the BS non-collocated/collocated condition is changed
NW configure UE to switch between Type-1 and Type-Y capability based on cell scenario changes
Subject #3: New UE behaves in case of UE is configured change between different Types
How to switch between types
Switching Delay
Interruption Time
Scell Activation

Embodiments of the disclosure makes non-collocated deployment for intra-band CA and inter-band EN-DC with overlapping spectrum in non-high speed mode achievable.

Embodiments of the disclosure achieves intra-band non-collocated deployment CA and inter-band EN-DC with overlapping spectrum non-collocated deployment, for which UE can support non-collocated deployment, and NW can configure UE switch between different UE capabilities/behaviors based on the NW situation change (rom collocated to non-collocated or non-collocated to collocated) and based on UE's capability indication (whether support non-collocated deployment and which kind of capability supported).

In embodiments, a wireless communication method performed by a network node is provided. The method comprises receiving capability information reported by a user equipment (UE) regarding a carrier aggregation capability of the UE and transmitting configuration information to the UE based on the received capability information. The configuration information comprises at least one of a primary cell configuration of the UE, a secondary cell configuration of the UE, or a configuration to control the UE for carrier aggregation capability switching.

In an embodiment, the transmitting of the configuration information to the UE comprises transmitting a first radio resource control (RRC) signaling to the UE for controlling the UE for carrier aggregation capability switching.

In an embodiment, the first RRC signaling comprises a first information element, the first information element is configured for indicating that the UE is switched between a first type of capability and another type of capability. In an embodiment, The first RRC signaling comprises a second information element, the second information element to configure the primary and secondary cells to have a same number of multiple input multiple output (MIMO) layers.

In an embodiment, the first information element comprises a first coding bit, wherein when the first coding bit is a first value, it indicates that the UE is switched from the another type of capability to the first type of capability; and when the first coding bit is a second value, it indicates that the UE is switched from the first type of capability to the another type of capability.

In an embodiment, the first information element comprises multiple coding bits. A first coding bit of the multiple coding bits indicates that a deployment of the network node is collocated or non-collocated; and/or a second coding bit of the multiple coding bits indicates that an operating assumption of the network node is a synchronous assumption or an asynchronous assumption; and/or a third coding bit of the multiple coding bits indicates a number of MIMO layers supported by each cell of the UE.

In an embodiment, the first RRC signaling is transmitted to the UE in a case that a first signaling and/or a second signaling is received from the UE. The first RRC signaling indicates that the UE is switched between a first type of capability and a second type of capability, in a case that the first signaling is received from the UE. The first RRC signaling indicates that the UE is switched between the first type of capability and a third and/or fourth type of capability, in a case that the second signaling is received from the UE. The first type of capability is a default capability for the UE. The first signaling indicates that the UE supports intra-band New Radio (NR) carrier aggregation of non-collocated and meets a requirement for a second type of UE. The second signaling indicates that the UE supports intra-band NR carrier aggregation of non-collocated and/or inter-band long-term evolution technology-New Radio (LTE-NR) carrier aggregation of non-collocated and meets a requirement for the third and/or fourth type of UE, wherein the third and/or fourth type of UE has a stronger multiple-input multiple-output (MIMO) capability than the second type of UE.

In an embodiment, the capability switching comprises that the UE is switched from a first type of capability to a second type of capability, a third type of capability and/or a fourth type of capability; or the UE is switched from the second type of capability, the third type of capability and/or the fourth type of capability, to the first type of capability. The first type of capability is a default capability for the UE.

In embodiments, a wireless communication method performed by a user equipment (UE). The method comprises reporting to a network node capability information regarding a carrier aggregation capability of the UE. and receiving configuration information from the network node. The configuration information comprises at least one of a primary cell configuration of the UE, a secondary cell configuration of the UE, or a configuration to control the UE for carrier aggregation capability switching.

In an embodiment, the capability information comprises first information and/or second information, wherein the first information is a signaling for indicating the carrier aggregation capability supported by the UE, and the second information is used to indicate a type of the carrier aggregation capability of the UE.

In an embodiment, the first information comprises at least one of a first signaling indicating that the UE supports intra-band new radio (NR) carrier aggregation of non-collocated and meets a requirement for a second type of UE, a second signaling indicating that the UE supports intra-band NR carrier aggregation of non-collocated and/or inter-band long-term evolution technology-NR (LTE-NR) carrier aggregation of non-collocated and meets a requirement for a third and/or fourth type of UE, wherein the third and/or fourth type of UE has a stronger multiple-input multiple-output (MIMO) capability than the second type of UE, a third signaling indicating a maximum number of MIMO layers per cell supported by the UE for non-collocated downlink reception. a fourth signaling indicating a maximum number of receive chains per cell supported by the UE for downlink reception, a fifth signaling indicating a category of a downlink frequency separation between cells supported by the UE, or a sixth signaling indicating a category of an uplink frequency separation between cells supported by the UE.

In an embodiment, the type of the carrier aggregation capability is based on at least one of the UE being a second type of UE and supporting intra-band NR carrier aggregation of non-collocated, the UE being a third and/or fourth type of UE and supporting intra-band NR carrier aggregation of non-collocated and/or inter-band LTE-NR carrier aggregation of non-collocated, wherein the third and/or fourth type of UE has a stronger multiple-input multiple-output (MIMO) capability than the second type of UE, a maximum number of MIMO layers per cell supported by the UE for non-collocated downlink reception, a maximum number of receive chains per cell supported by the UE for downlink reception, a category of a downlink frequency separation between cells supported by the UE, or a category of an uplink frequency separation between cells supported by the UE.

In an embodiment, the third or fourth type of UE has a stronger multiple-input multiple-output (MIMO) capability than the second type of UE comprises at least one of each NR cell of the third and/or fourth type of UE supports more MIMO layers than each NR cell of the second type of UE, each LTE cell of the third and/or fourth type of UE supports the same number of MIMO layers as each LTE cell of the second type of UE, or each LTE cell of the third and/or fourth type of UE supports more MIMO layers than each LTE cell of the second type of UE.

In an embodiment, each NR cell of the second type of UE supports up to two MIMO layers, each LTE cell of the second type of UE supports up to two MIMO layers, each NR cell of the third and/or fourth type of UE supports up to four MIMO layers, and each LTE cell of the third and/or fourth type of UE supports up to two or four MIMO layers.

In an embodiment, the first signaling, the second signaling, the fifth signaling and the sixth signaling are reported per band combination, and are applied to a frequency range of frequency range 1 (FR1). The third signaling is reported per cell per band per band combination, is conditionally forced reporting, and is applied to a frequency range of FR1 and a frequency range of frequency range 2 (FR2). The fourth signaling is reported per cell per band per band combination, and is applied only to the FR1, or to both the FR1 and the FR2.

In an embodiment, in a case where the UE is the second type of UE and supports intra-band NR carrier aggregation of non-collocated, the first information comprises at least the first signaling. In an embodiment, in a case where the UE is the third and/or fourth type of UE and supports intra-band NR carrier aggregation of non-collocated and/or inter-band LTE-NR carrier aggregation of non-collocated, the first information comprises at least the second signaling.

In an embodiment, the requirement for the second type of UE comprises a maximum receiving time difference (MRTD) requirement and/or a RF requirement for the second type of UE. The requirement for the third or fourth type of UE comprises a MRTD requirement and/or a RF requirement for the third or fourth type of UE.

In an embodiment, the receiving of the configuration information transmitted by the network node comprises receiving a first radio resource control (RRC) signaling for controlling the UE for carrier aggregation capability switching.

In embodiments, a network node is provided. The network node comprises at least one transceiver and at least one processor. The at least one processor is configured to receive, via the at least one transceiver, capability information reported by a user equipment (UE) regarding a carrier aggregation capability of the UE. The at least one processor is configured to transmit, via the least one transceiver, configuration information to the UE based on the received capability information. The configuration information comprises at least one of a primary cell configuration of the UE, a secondary cell configuration of the UE, or a configuration to control the UE for carrier aggregation capability switching.

In embodiments, a user equipment (UE) for use in a communication network. The UE comprises at least one transceiver and at least one processor. The at least one processor is configured to report, via the at least one transceiver, to a network node capability information regarding a carrier aggregation capability of the UE. The at least one processor is configured to receive, via the at least one transceiver, configuration information from the network node. The configuration information comprises at least one of a primary cell configuration of the UE, a secondary cell configuration of the UE, or a configuration to control the UE for carrier aggregation capability switching.

Each embodiment herein may be used in combination with any other embodiment(s) described herein.

According to an embodiment of the present disclosure, a computer readable storage medium storing instructions is also provided. The instructions, when executed by at least one processor, cause the at least one processor to perform the above various wireless communication methods according to the example embodiments. Examples of computer-readable storage media herein include: Read Only Memory (ROM), Random Access Programmable Read Only Memory (RAPROM), Electrically Erasable Programmable Read Only Memory (EEPROM), Random Access Memory (RAM), Dynamic Random Access Memory (DRAM), Static Random Access Memory (SRAM), flash memory, non-volatile memory, CD-ROM, CD-R, CD+R, CD-RW, CD+RW, DVD-ROM, DVD-R, DVD+R, DVD-RW, DVD+RW, DVD-RAM, BD-ROM, BD-R, BD-R LTH, BD-RE, Blue-ray or optical disk storage, Hard Disk Drive (HDD), Solid State Drive (SSD), card storage (such as multimedia cards, secure digital (SD) cards or extremely fast digital (XD) cards), magnetic tapes, floppy disks, magneto-optical data storage devices, optical data storage devices, hard disks, solid state disks, and any other devices that are configured to store computer programs and any associated data, data files and data structures in a non-transitory manner and provide the computer programs and any associated data, data files and data structures to a processor or computer so that the processor or computer can execute the computer programs. The instructions or computer programs in the computer-readable storage medium described above may be executed in an environment deployed in a computer device, such as client, host, proxy device, server, etc. In addition, in one example, the computer programs and any associated data, data files, and data structures are distributed on a networked computer system, so that the computer programs and any associated data, data files, and data structures are stored, accessed and executed through one or more processors or computers in a distributed manner.

Other example embodiments will readily be conceived by those skills in the art after considering the specification. The present disclosure is intended to cover any variation, use, or adaptation of the present disclosure that follows the general principle of the present disclosure and includes commonly known or customary technical means in the art not disclosed herein. The specification and embodiments are to be considered exemplary only, and the true scope and spirit of the disclosure is limited by the claims.

While the disclosure has been illustrated and described with reference to various embodiments, it will be understood that the various embodiments are intended to be illustrative, not limiting. It will further be understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. A wireless communication method performed by a network node, the method comprising:
receiving capability information reported by a user equipment (UE) regarding a carrier aggregation capability of the UE; and
transmitting configuration information to the UE based on the received capability information,
wherein the configuration information comprises at least one of a primary cell configuration of the UE, a secondary cell configuration of the UE, or a configuration to control the UE for carrier aggregation capability switching.

2. The wireless communication method according to claim 1, wherein the transmitting of the configuration information to the UE comprises:
transmitting a first radio resource control (RRC) signaling to the UE for controlling the UE for carrier aggregation capability switching.

3. The wireless communication method according to claim 2, wherein,
the first RRC signaling comprises a first information element, the first information element is configured for indicating that the UE is switched between a first type of capability and another type of capability; and/or
the first RRC signaling comprises a second information element, the second information element to configure the primary and secondary cells to have a same number of multiple input multiple output (MIMO) layers.

4. The wireless communication method according to claim 3, wherein the first information element comprises a first coding bit, wherein when the first coding bit is a first value, it indicates that the UE is switched from the another type of capability to the first type of capability; and when the first coding bit is a second value, it indicates that the UE is switched from the first type of capability to the another type of capability.

5. The wireless communication method according to claim 3, wherein the first information element comprises multiple coding bits,
wherein a first coding bit of the multiple coding bits indicates that a deployment of the network node is collocated or non-collocated; and/or
a second coding bit of the multiple coding bits indicates that an operating assumption of the network node is a synchronous assumption or an asynchronous assumption; and/or
a third coding bit of the multiple coding bits indicates a number of MIMO layers supported by each cell of the UE.

6. The wireless communication method according to claim 2, wherein the first RRC signaling is transmitted to the UE in a case that a first signaling and/or a second signaling is received from the UE,
wherein the first RRC signaling indicates that the UE is switched between a first type of capability and a second type of capability, in a case that the first signaling is received from the UE;
wherein, the first RRC signaling indicates that the UE is switched between the first type of capability and a third and/or fourth type of capability, in a case that the second signaling is received from the UE;
wherein the first type of capability is a default capability for the UE;
wherein the first signaling indicates that the UE supports intra-band New Radio (NR) carrier aggregation of non-collocated and meets a requirement for a second type of UE;
the second signaling indicates that the UE supports intra-band NR carrier aggregation of non-collocated and/or inter-band long-term evolution technology-New Radio (LTE-NR) carrier aggregation of non-collocated and meets a requirement for the third and/or fourth type of UE, wherein the third and/or fourth type of UE has a stronger multiple-input multiple-output (MIMO) capability than the second type of UE.

7. The wireless communication method according to claim 1, wherein the capability switching comprises:
the UE is switched from a first type of capability to a second type of capability, a third type of capability and/or a fourth type of capability; or
the UE is switched from the second type of capability, the third type of capability and/or the fourth type of capability, to the first type of capability,
wherein the first type of capability is a default capability for the UE.

8. A wireless communication method performed by a user equipment (UE), the method comprising:
reporting to a network node capability information regarding a carrier aggregation capability of the UE; and
receiving configuration information from the network node,
wherein the configuration information comprises at least one of a primary cell configuration of the UE, a secondary cell configuration of the UE, or a configuration to control the UE for carrier aggregation capability switching.

9. The wireless communication method according to claim 8, wherein the capability information comprises first information and/or second information, wherein the first information is a signaling for indicating the carrier aggregation capability supported by the UE, and the second information is used to indicate a type of the carrier aggregation capability of the UE.

10. The wireless communication method according to claim 9, wherein the first information comprises at least one of:
a first signaling indicating that the UE supports intra-band new radio (NR) carrier aggregation of non-collocated and meets a requirement for a second type of UE;
a second signaling indicating that the UE supports intra-band NR carrier aggregation of non-collocated and/or inter-band long-term evolution technology-NR (LTE-NR) carrier aggregation of non-collocated and meets a requirement for a third and/or fourth type of UE, wherein the third and/or fourth type of UE has a stronger multiple-input multiple-output (MIMO) capability than the second type of UE;
a third signaling indicating a maximum number of MIMO layers per cell supported by the UE for non-collocated downlink reception;
a fourth signaling indicating a maximum number of receive chains per cell supported by the UE for downlink reception;
a fifth signaling indicating a category of a downlink frequency separation between cells supported by the UE;
a sixth signaling indicating a category of an uplink frequency separation between cells supported by the UE.

11. The wireless communication method according to claim 9, wherein the type of the carrier aggregation capability is based on at least one of:
the UE being a second type of UE and supporting intra-band NR carrier aggregation of non-collocated;
the UE being a third and/or fourth type of UE and supporting intra-band NR carrier aggregation of non-collocated and/or inter-band LTE-NR carrier aggregation of non-collocated, wherein the third and/or fourth type of UE has a stronger multiple-input multiple-output (MIMO) capability than the second type of UE;
a maximum number of MIMO layers per cell supported by the UE for non-collocated downlink reception;
a maximum number of receive chains per cell supported by the UE for downlink reception;
a category of a downlink frequency separation between cells supported by the UE;
a category of an uplink frequency separation between cells supported by the UE.

12. The wireless communication method according to claim 10, wherein the third or fourth type of UE has a stronger multiple-input multiple-output (MIMO) capability than the second type of UE comprises at least one of:
each NR cell of the third and/or fourth type of UE supports more MIMO layers than each NR cell of the second type of UE;
each LTE cell of the third and/or fourth type of UE supports the same number of MIMO layers as each LTE cell of the second type of UE;
each LTE cell of the third and/or fourth type of UE supports more MIMO layers than each LTE cell of the second type of UE.

13. The wireless communication method according to claim 12, wherein each NR cell of the second type of UE supports up to two MIMO layers, each LTE cell of the second type of UE supports up to two MIMO layers, each NR cell of the third and/or fourth type of UE supports up to four MIMO layers, and each LTE cell of the third and/or fourth type of UE supports up to two or four MIMO layers.

14. The wireless communication method according to claim 10, wherein the first signaling, the second signaling, the fifth signaling and the sixth signaling are reported per band combination, and are applied to a frequency range of frequency range 1 (FR1);
the third signaling is reported per cell per band per band combination, is conditionally forced reporting, and is applied to a frequency range of FR1 and a frequency range of frequency range 2 (FR2);
the fourth signaling is reported per cell per band per band combination, and is applied only to the FR1, or to both the FR1 and the FR2.

15. The wireless communication method according to claim 10, wherein in a case where the UE is the second type of UE and supports intra-band NR carrier aggregation of non-collocated, the first information comprises at least the first signaling; and/or,
in a case where the UE is the third and/or fourth type of UE and supports intra-band NR carrier aggregation of non-collocated and/or inter-band LTE-NR carrier aggregation of non-collocated, the first information comprises at least the second signaling.

16. The wireless communication method according to claim 10, wherein the requirement for the second type of UE comprises a maximum receiving time difference (MRTD) requirement and/or a RF requirement for the second type of UE;
the requirement for the third or fourth type of UE comprises a MRTD requirement and/or a RF requirement for the third or fourth type of UE.

17. The wireless communication method according to claim 8, wherein the receiving of the configuration information transmitted by the network node comprises:
receiving a first radio resource control (RRC) signaling for controlling the UE for carrier aggregation capability switching.

18. A network node comprising:
at least one transceiver; and
at least one processor configured to:
receive, via the at least one transceiver, capability information reported by a user equipment (UE) regarding a carrier aggregation capability of the UE; and
transmit, via the least one transceiver, configuration information to the UE based on the received capability information,
wherein the configuration information comprises at least one of a primary cell configuration of the UE, a secondary cell configuration of the UE, or a configuration to control the UE for carrier aggregation capability switching.

19. A user equipment (UE) for use in a communication network, the UE comprising:
at least one transceiver;
at least one processor configured to:
report, via the at least one transceiver, to a network node capability information regarding a carrier aggregation capability of the UE; and
receive, via the at least one transceiver, configuration information from the network node,
wherein the configuration information comprises at least one of a primary cell configuration of the UE, a secondary cell configuration of the UE, or a configuration to control the UE for carrier aggregation capability switching.
